(19) United States
(12) Patent Application Publication
(10) Pub. No.: US 2025/0089715 A1
(43) Pub. Date: Mar. 20, 2025

(54) INSECTICIDAL MIXTURES

(71) Applicant: ADAMA MAKHTESHIM LTD., Beer Sheva (IL)

(72) Inventor: Pradeep KULKARNI, Telangana (IN)

(73) Assignee: ADAMA MAKHTESHIM LTD., Beer Sheva (IL)

(21) Appl. No.: 18/576,998

(22) PCT Filed: Jul. 6, 2022
(86) PCT No.: PCT/IL2022/050729

§ 371 Date: Jan. 5, 2024

(30) Foreign Application Priority Data
Jul. 6, 2021 (IN) 202111030414

(51) Int. Cl. A01N 43/56; A01N 37/34; A01N 43/713; A01P 7/04

(52) U.S. Cl. CPC A01N 43/56; A01N 37/34; A01N 43/713; A01P 7/04

(57) ABSTRACT

The present invention relates to insecticidal combinations comprising a) an anthranilamide compound of formula (I) and b) tau-fluvalinate.

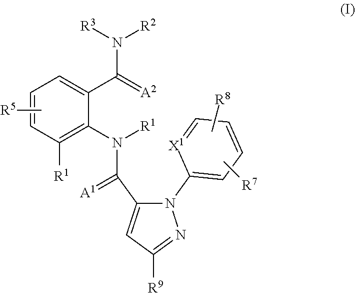

### FIELD OF THE PRESENT SUBJECT MATTER

The present subject matter relates to an insecticidal combination that comprises a combination of (i) an anthranilamide compound of formula (I); and (ii) tau-fluvalinate.

### BACKGROUND OF THE PRESENT SUBJECT MATTER

Crop protection is critical from early stages of crop development. Preventing pests and diseases at the root of the crop during root development leads to increased crop health and yield.

The vulnerability of crops to pests makes pest control one of the major management components of the total crop production system. Insects are very destructive to crop plants and can significantly reduce crop yields and quality. Insecticides help minimize this damage by controlling insect pests. Many insecticidal agents and compositions are commercially available for these purposes.

Anthranilamide compounds of formula (I) are a class of insecticides that provides control through action on the ryanodine receptor. These compounds activate this receptor, leading to the unregulated loss of stored calcium. This causes impaired regulation of muscle contraction.

Combinations of insecticides are typically used to broaden spectrum of control, to minimize the doses of chemicals used, to retard resistance development and to reduce the cost of the treatment through additive effect. Although many combinations of insecticidal agents have been studied, a synergistic effect is rarely attained.

Further, the activity and selectivity behavior of any specific mixture is difficult to predict since the behavior of each single insecticide in the mixture is often affected by the presence of the other components and the activity of the mixture may also vary considerably depending on chemical character, plant species, growth stage, and environmental conditions. Mostly, this practice results in reduced activity of the insecticides in the mixture.

Practical agricultural experience has shown that the repeated and exclusive application of an individual active compound in the control of insect pests leads in many cases to a selection of those pests which have developed natural or adapted resistance against the active compound in question. Effective control of these pests with the active compound in question is then no longer possible.

In order to reduce the risk of insect pests becoming resistant to certain active compounds, mixtures of different active compounds are nowadays conventionally employed for controlling insect pests. By combining active compounds having different mechanisms of action, it is possible to ensure successful control over a relatively long period of time.

There is also the need for pest control agents that combine knock-down activity with prolonged control, that is, fast action with long lasting action.

It was therefore an object of the present invention to provide insecticidal combinations which (i) reduces dosage rate, (ii) enhances the spectrum of activity or combining knock-down activity with prolonged control or (iii) provides resistance management.

It is an object of the present invention to provide, combinations and compositions which, when applied at a reduced total amount of active compounds, have improved activity against the harmful pests and a broadened activity spectrum. It is a further object of the present invention to provide, combinations and compositions which provide effective resistance management and insect pests control, at application rates which are as low as possible.

We have accordingly found that this may be achieved by combinations and compositions, comprising an anthranilamide compound of formula (I) and tau-fluvalinate. Moreover, we have found that a combination of an anthranilamide compound of formula (I) and tau-fluvalinate, being applied simultaneously, that is jointly or separately, or in succession allows better control of insect pests than is possible with the individual compounds alone, providing synergistic results.

In light of the above, there is still a need for novel insecticidal compositions that exhibit synergistically enhanced action, a broader scope of activity and reduced cost of treatment.

### SUMMARY OF THE INVENTION

The present subject matter relates to an insecticidal combination comprising: (i) an anthranilamide compound of formula (I)

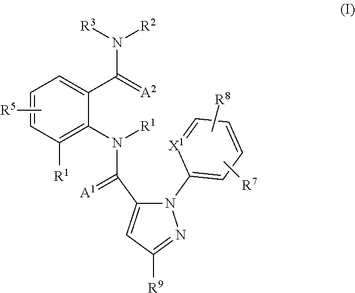

in which
A¹ and A² independently of one another represent oxygen or sulfur,
X¹ represents N or CR¹⁰,
R¹ represents hydrogen or represents C₁-C₆-alkyl, C₂-C₆-alkenyl, C₂-C₆-alkynyl or C₃-C₆-cycloalkyl, each of which is optionally mono- or polysubstituted, where the substituents independently of one another may be selected from the group consisting of R⁶, halogen, cyano, nitro, hydroxyl, C₁-C₄-alkoxy, C₁-C₄-alkylthio, C₁-C₄-alkylsulfinyl, C₁-C₄-alkylsulfonyl, C₂-C₄-alkoxycarbonyl, C₁-C₄-alkylamino, C₂-C₈-dialkylamino, C₃-C₆-cycloalkylamino, (C₁-C₄-alkyl)-C₃-C₆-cycloalkylamino and R¹¹,
R² represents hydrogen, C₁-C₆-alkyl, C₂-C₆-alkenyl, C₂-C₆-alkynyl, C₃-C₆-cycloalkyl, C₁-C₄-alkoxy, C₁-C₄-alkylamino, C₂-C₈-dialkylamino, C₃-C₆-cycloalkylamino, C₂-C₆-alkoxycarbonyl or C₂-C₆-alkylcarbonyl,
R³ represents hydrogen, R¹¹ or represents C₁-C₆-alkyl, C₂-C₆-alkenyl, C₂-C₆-alkynyl, C₃-C₆-cycloalkyl, each of which is optionally mono- or polysubstituted, where the substituents independently of one another may be selected from the group consisting of R⁶, halogen, cyano, nitro, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₂-C₆-alkoxycarbonyl, C₂-C₆-alkylcarbonyl, C₃-C₆-trialkylsilyl, R¹¹, phenyl, phenoxy and a 5- or 6-membered heteroaromatic ring, where each phenyl, phenoxy and 5- or 6-membered heteroaromatic ring may optionally be substituted and where the substituents independently of one another may be selected from one to three radicals W or one or more radicals R¹², or
R² and R³ may be attached to one another and form the ring M,
R⁴ represents hydrogen, C₁-C₆-alkyl, C₂-C₆-alkenyl, C₂-C₆-alkynyl, C₃-C₆-cycloalkyl, C₁-C₆-haloalkyl, C₂-C₆-haloalkenyl, C₂-C₆-haloalkynyl, C₃-C₆-halocycloalkyl, halogen, cyano, nitro, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl, C₁-C₄-alkylamino, C₂-C₈-dialkylamino, C₃-C₆-cycloalkylamino, C₃-C₆-trialkylsilyl or represents phenyl, benzyl or phenoxy, each of which is optionally mono- or polysubstituted, where the substituents independently of one another may be selected from the group consisting of C₁-C₄-alkyl, C₂-C₄-alkenyl, C₂-C₄-alkynyl, C₃-C₆-cycloalkyl, C₁-C₄-haloalkyl, C₂-C₄-haloalkenyl, C₂-C₄-haloalkynyl, C₃-C₆-halocycloalkyl, halogen, cyano, nitro, C₁-C₄-alkoxy, C₁-C₄-haloalkoxy, C₁-C₄-alkylthio, C₁-C₄-alkylsulfinyl, C₁-C₄-alkylsulfonyl, C₁-C₄-alkylamino, C₂-C₈-dialkylamino, C₃-C₆-cycloalkylamino, C₃-C₆-(alkyl)cycloalkylamino, C₂-C₄-alkylcarbonyl, C₂-C₆-alkoxycarbonyl, C₂-C₆-alkylaminocarbonyl, C₃-C₈-dialkylaminocarbonyl and C₃-C₆-trialkylsilyl,
R⁵ and R⁸ in each case independently of one another represent hydrogen, halogen or represent in each case optionally substituted C₁-C₄-alkyl, C₁-C₄-haloalkyl, R¹², G, J, —OJ, —OG, —S(O)ₚ-J, —S(O)ₚG, —S(O)ₚ-phenyl, where the substituents independently of one another may be selected from one to three radicals W or from the group consisting of R¹², C₁-C₁₀-alkyl, C₂-C₆-alkenyl, C₂-C₆-alkynyl, C₁-C₄-alkoxy and C₁-C₄-alkylthio, where each substituent may be substituted by one or more substituents independently of one another selected from the group consisting of G, J, R⁶, halogen, cyano, nitro, amino, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl, C₁-C₄-alkylamino, C₂-C₈-dialkylamino, C₃-C₆-trialkylsilyl, phenyl and phenoxy, where each phenyl or phenoxy ring may optionally be substituted and where the substituents independently of one another may be selected from one to three radicals W or one or more radicals R¹²,
G in each case independently of one another represents a 5- or 6-membered non-aromatic carbocyclic or heterocyclic ring which may optionally contain one or two ring members from the group consisting of C(═O), SO and S(═O)₂ and which may optionally be substituted by one to four substituents independently of one another selected from the group consisting of C₁-C₂-alkyl, halogen, cyano, nitro and C₁-C₂-alkoxy, or independently of one another represents C₂-C₆-alkenyl, C₂-C₆-alkynyl, C₃-C₇-cycloalkyl, (cyano)-C₃-C₇-cycloalkyl, (C₁-C₄-alkyl)-C₃-C₆-cycloalkyl, (C₃-C₆-cycloalkyl)-C₁-C₄-alkyl, where each cycloalkyl, (alkyl)cycloalkyl and (cycloalkyl)alkyl may optionally be substituted by one or more halogen atoms,
J in each case independently of one another represents an optionally substituted 5- or 6-membered heteroaromatic ring, where the substituents independently of one another may be selected from one to three radicals W or one or more radicals R¹²,
R⁶ independently of one another represents —C(=E¹)R¹⁹, -L(=E¹)R¹⁹, —C(=E¹)LR¹⁹, -LC(=E¹)LR¹⁹, —OP(=Q)(OR¹⁹)₂, —SO₂LR¹⁸ or -LSO₂LR¹⁹, where each E¹ independently of one another represents O, S, N—R¹⁵, N—OR¹⁵, N—N(R¹⁵)₂, N—S═O, N—CN or N—NO₂,
R⁷ represents hydrogen, C₁-C₄-alkyl, C₁-C₄-haloalkyl, halogen, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl,
R⁹ represents C₁-C₄-haloalkyl, C₁-C₄-haloalkoxy, C₁-C₄-haloalkylsulfinyl or halogen,
R¹⁰ represents hydrogen, C₁-C₄-alkyl, C₁-C₄-haloalkyl, halogen, cyano or C₁-C₄-haloalkoxy,
R¹¹ in each case independently of one another represents in each case optionally mono- to trisubstituted C₁-C₆-alkylthio, C₁-C₆-alkylsulfenyl, C₁-C₆-haloalkylthio, C₁-C₆-haloalkylsulfenyl, phenylthio or phenylsulfenyl, where the substituents independently of one another may be selected from the list W, —S(O)ₙN(R¹⁶)₂, —C(═O)R¹³, -L(C═O)R¹⁴, —S(C═O)LR¹⁴, —C(═O)LR¹³, —S(O)ₙNR¹³C(═O)R¹³, —S(O)ₙNR¹³C(═O)LR¹⁴ or —S(O)ₙNR¹³S(O)₂LR¹⁴,
L in each case independently of one another represents O, NR¹⁸ or S,
R¹² in each case independently of one another represents —B(OR¹⁷)₂, amino, SH, thiocyanato, C₃-C₈-trialkylsilyloxy, C₁-C₄-alkyl disulfides, —SF₅, —C(=E¹)R¹⁹, -LC(=E¹)R¹⁹, —C(=E¹)LR¹⁹, -LC(=E¹)LR¹⁹, —OP(=Q)(OR¹⁹)₂, —SO₂LR¹⁹ or -LSO₂LR¹⁹,
Q represents O or S,
R¹³ in each case independently of one another represents hydrogen or represents in each case optionally mono- or polysubstituted C₁-C₆-alkyl, C₂-C₆-alkenyl, C₂-C₆-alkynyl or C₃-C₆-cycloalkyl, where the substituents independently of one another may be selected from the group consisting of R⁶, halogen, cyano, nitro, hydroxyl, C₁-C₄-alkoxy, C₁-C₄-alkylsulfinyl, C₁-C₄-alkylsulfonyl, C₁-C₄-alkylamino, C₂-C₈-dialkylamino, C₃-C₆-cycloalkylamino or (C₁-C₄-alkyl)-C₃-C₆-cycloalkylamino,
R¹⁴ in each case independently of one another represents in each case optionally mono- or polysubstituted C₂-C₂₀-alkenyl, C₂-C₂₀-alkynyl or C₃-C₆-cycloalkyl, where the substituents independently of one another may be selected from the group consisting of R⁶, halogen, cyano, nitro, hydroxyl, C₁-C₄-alkoxy, C₁-C₄-alkylsulfinyl, C₁-C₄-alkylsulfonyl, C₁-C₄-alkylamino, C₂-C₈-dialkylamino, C₃-C₆-cycloalkylamino and (C₁-C₄-alkyl)-C₃-C₆-cycloalkylamino or represent optionally substituted phenyl, where the substituents independently of one another may be selected from one to three radicals W or one or more radicals R¹²,
R¹⁵ in each case independently of one another represents hydrogen or represents in each case optionally mono- or polysubstituted C₁-C₆-haloalkyl or C₁-C₆-alkyl, where the substituents independently of one another may be selected from the group consisting of cyano, nitro, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl, C₁-C₄-alkylamino, C₂-C₈-dialkylamino, C₂-C₆-alkoxycarbonyl, C₂-C₆-alkylcarbonyl, C₃-C₆-trialkylsilyl and optionally substituted phenyl, where the substituents independently of one another may be selected from one to three radicals W or one or more radicals R¹², or N(R¹⁵)₂ represents a cycle which forms the ring M,
R¹⁶ represents C₁-C₁₂-alkyl or C₁-C₁₂-haloalkyl, or N(R¹⁶)₂ represents a cycle which forms the ring M,
R¹⁷ in each case independently of one another represents hydrogen or C₁-C₄-alkyl, or B(OR¹⁷)₂ represents a ring in which the two oxygen atoms are attached via a chain having two to three carbon atoms which are optionally substituted by one or two substituents independently of one another selected from the group consisting of methyl and C₂-C₆-alkoxycarbonyl,
R¹⁸ in each case independently of one another represents hydrogen, C₁-C₆-alkyl or C₁-C₆-haloalkyl, or N(R¹³)(R¹⁸) represents a cycle which forms the ring M,
R¹⁹ in each case independently of one another represents hydrogen or represents in each case mono- or polysubstituted C₁-C₆-alkyl, where the substituents independently of one another may be selected from the group consisting of cyano, nitro, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl, C₁-C₄-alkylamino, C₂-C₈-dialkylamino, CO₂H, C₂-C₆-alkoxycarbonyl, C₂-C₆-alkylcarbonyl, C₃-C₆-trialkylsilyl and optionally substituted phenyl, where the substituents independently of one another may be selected from one to three radicals W, C₁-C₆-haloalkyl, C₃-C₆-cycloalkyl or phenyl or pyridyl, each of which is optionally mono- to trisubstituted by W,
M in each case represents an optionally mono- to tetrasubstituted ring which, in addition to the nitrogen atom attached to the substituent pair R¹³ and R¹⁸, (R¹⁵)₂ or (R¹⁶)₂, contains two to six carbon atoms and optionally additionally a further nitrogen, sulfur or oxygen atom, where the substituents independently of one another may be selected from the group consisting of C₁-C₂-alkyl, halogen, cyano, nitro and C₁-C₂-alkoxy,
W in each case independently of one another represents C₁-C₄-alkyl, C₂-C₄-alkenyl, C₂-C₄-alkynyl, C₃-C₆-cycloalkyl, C₁-C₄-haloalkyl, C₂-C₄-haloalkenyl, C₂-C₄-haloalkynyl, C₃-C₆-halocycloalkyl, halogen, cyano, nitro, C₁-C₄-alkoxy, C₁-C₄-haloalkoxy, C₁-C₄-alkylthio, C₁-C₄-alkylsulfonyl, C₁-C₄-alkylamino, C₂-C₈-dialkylamino, C₃-C₆-cycloalkylamino, (C₁-C₄-alkyl)-C₃-C₆-cycloalkylamino, C₂-C₄-alkylcarbonyl, C₂-C₆-alkoxycarbonyl, CO₂H, C₂-C₆-alkylaminocarbonyl, C₃-C₈-dialkylaminocarbonyl or C₃-C₆-trialkylsilyl,
n in each case independently of one another represents 0 or 1,
p in each case independently of one another represents 0, 1 or 2,
where, if (a) R⁵ represents hydrogen, C₁-C₆-alkyl, C₁-C₆-haloalkyl, C₂-C₆-haloalkenyl, C₂-C₆-haloalkynyl, C₁-C₄-haloalkoxy, C₁-C₄-haloalkylthio or halogen and (b) R⁸ represents hydrogen, C₁-C₆-alkyl, C₁-C₆-haloalkyl, C₂-C₆-haloalkenyl, C₂-C₆-haloalkynyl, C₁-C₄-haloalkoxy, C₁-C₄-haloalkylthio, halogen, C₂-C₄-alkylcarbonyl, C₂-C₆-alkoxycarbonyl, C₂-C₆-alkylaminocarbonyl or C₃-C₈ dialkylaminocarbonyl, (c) at least one substituent selected from the group consisting of R⁶, R¹¹ and R¹² if present and (d) if R¹² is not present, at least one of the radicals R⁶ and R¹¹ is different from C₂-C₆-alkylcarbonyl, C₂-C₆-alkoxycarbonyl, C₂-C₆-alkylaminocarbonyl and C₃-C₈-dialkylaminocarbonyl, and where the compound of the general formula (I) may also be an N-oxide or salt; and
(ii) tau-fluvalinate.

The present subject matter also provides an insecticidal combination comprising: (i) an anthranilamide compound of formula (I); and (ii) tau fluvalinate for controlling chewing pests.

The present subject matter also provides an insecticidal composition that comprises: (i) an anthranilamide compound of formula (I); and (ii) tau fluvalinate.

The present subject matter also provides an insecticidal composition that comprises: (i) an anthranilamide compound of formula (I); and (ii) tau fluvalinate for controlling chewing pests.

The present subject matter also relates to a method for control of insects by contacting the insect or their food supply, habitat, breeding grounds or their locus with a synergistically effective amount of a combination of (i) an anthranilamide compound of formula (I); and (ii) tau fluvalinate.

The present subject matter also relates to a method for control of chewing pests by contacting the insect or their food supply, habitat, breeding grounds or their locus with a synergistically effective amount of a combination of (i) an anthranilamide compound of formula (I); and (ii) tau fluvalinate.

The present subject matter also relates to a method of protecting plants from attack or infestation by insects comprising contacting the plant, or the soil or water in which the plant is growing, with a synergistically effective amount of a combination of (i) an anthranilamide compound of formula (I); and (ii) tau fluvalinate.

### BRIEF DESCRIPTION OF THE FIGURES

FIG. 1. is a bar diagram showing S. littoralis mortality rate (percentage, %) as a function of Chlorantraniliprole (Coragen®) concentration (ppm).

FIG. 2 is a bar diagram showing S. littoralis mortality rate (percentage, %) as a function of Tau-fluvalinate (Mavrik®) concentration (ppm).

FIG. 3. is a bar diagram showing H. armigera mortality rate (percentage, %) as a function of Chlorantraniliprole (Coragen®) concentration (ppm).

FIG. 4 is a bar diagram showing H. armigera mortality rate (percentage, %) as a function of Tau-fluvalinate (Mavrik®) concentration (ppm).

FIG. 5 is a bar diagram showing % ROC against infected bolls upon treatment of pink bollworm-infected cotton with Tau-fluvalinate, Chlorantraniliprole or a combination thereof (CTPRL+Tau 30+120) for each one of the locations (Piprata and Jamshedpur) and for an average thereof (Avg). % ROC is the percentage of Pink Bollworm control based on insect count; infested bolls (Inf boll) means the incidence of cotton balls with pink bollworm damage.

FIG. 6 is a bar diagram showing % ROC against larval count (number of larvae in a certain number of bolls evaluated) upon treatment of pink bollworm-infected cotton with Tau-fluvalinate, Chlorantraniliprole or a combination thereof (CTPRL+Tau 30+120) for each one of the locations (Piprata and Jamshedpur) and for an average thereof (Avg).

### DETAILED DESCRIPTION OF SPECIFIC EMBODIMENTS OF THE INVENTION

### Definitions

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter pertains.

As used herein the term “plant” or “crop” includes reference to whole plants, plant organs (e.g. leaves, stems, twigs, roots, trunks, limbs, shoots, fruits etc.), plant cells, or plant seeds. This term also encompasses plant crops such as fruits. The term “plant” may also include the propagation material thereof, which may include all the generative parts of the plant such as seeds and vegetative plant material such as cuttings and tubers, which can be used for the multiplication of the plant. It may also include spores, corms, bulbs, rhizomes, sprouts basal shoots, stolons, and buds and other parts of plants, including seedlings and young plants, which are to be transplanted after germination or after emergence from soil.

As used herein, the term “locus” includes a habitat, breeding ground, plant, propagation material, soil, area, material or environment in which a pest is growing or may grow.

As used herein, the terms “control” or “controlling” are meant to include, but are not limited to, any killing, growth regulating, inhibiting or interfering with the normal life cycle of the pest activities of a given pest. These terms include for example preventing larvae from developing into mature insects, modulating the emergence of pests from eggs including preventing eclosion, degrading the egg material, suffocation, reducing gut motility, inhibiting the formation of chitin, disrupting mating or sexual communication, and preventing feeding activity.

As used herein, the term “effective amount” refers to an amount of the mixture that, when ingested, contacted with or sensed, is sufficient to achieve a good level of control. It refers to the amount of the mixture necessary to kill an insect or otherwise deter the feeding of an insect from the source. When an insect comes into contact with an insecticidally effective amount of a composition, the results are typically death of the insect.

As used herein, the term “mixture” or “combination” refers, but is not limited to, a combination in any physical form, e.g., blend, solution, alloy, or the like.

As used herein, the term “cultivated plants” includes plants which have been modified by breeding, mutagenesis or genetic engineering. Genetically modified plants are plants, which genetic material has been modified by the use of recombinant DNA techniques. Typically, one or more genes have been integrated into the genetic material of such a plant in order to improve certain properties of the plant.

The term “plant health” comprises various sorts of improvements of plants that are not connected to the control of pests. For example, advantageous properties that may be mentioned are improved crop characteristics including: emergence, crop yields, protein content, oil content, starch content, more developed root system (improved root growth), improved stress tolerance (e.g. against drought, heat, salt, UV, water, cold), reduced ethylene (reduced production and/or inhibition of reception), increase in plant height, bigger leaf blade, less dead basal leaves, stronger tillers, greener leaf color, pigment content, photosynthetic activity, less input needed (such as fertilizers or water), less seeds needed, more productive tillers, earlier flowering, early grain maturity, less plant verse (lodging), increased shoot growth, enhanced plant vigor, increased plant stand and early and better germination; or any other advantages familiar to a person skilled in the art.

As used herein the term “knock-down activity” or “knock-down treatment” means an application of one or more insecticides for controlling insect infestation of the plant or locus before and/or after an infestation or before and/or after insect damage are shown and/or when the pest pressure is low/high. Insect pressure may be assessed based on the conditions associated with insect development such as population density and certain environmental conditions.

As used herein the term “prolonged control” means obtaining insecticidal activity over an extended period after the application of one or more insecticide for controlling insect infestation of the plant or locus over an extended period of time, before and/or after an infestation or before and/or after insect damage are shown and/or when the insect pressure is low/high. Insect pressure may be assessed based on the conditions associated with insect development such as population density and certain environmental conditions.

As used herein, the phrase “agriculturally acceptable carrier” means carriers which are known and accepted in the art for the formation of compositions for agricultural or horticultural use.

Throughout the application, descriptions of various embodiments use the term “comprising”; however, it will be understood by one of skill in the art, that in some specific instances, an embodiment can alternatively be described using the language “consisting essentially of” or “consisting of.”

The term “a” or “an” as used herein includes the singular and the plural, unless specifically stated otherwise. Therefore, the terms “a,” “an” or “at least one” can be used interchangeably in this application.

For purposes of better understanding the present teachings and in no way limiting the scope of the teachings, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques. In this regard, used of the term “about” herein specifically includes ±10% from the indicated values in the range. In addition, the endpoints of all ranges directed to the same component or property herein are inclusive of the endpoints, are independently combinable, and include all intermediate points and ranges.

### Insecticidal Combinations

It has been surprisingly found that by combining insecticides having different modes of action (MOA), i.e., systemic action, ingestion action and contact and stomach action, insecticidal mixtures are produced that exhibit a broad spectrum of control and high efficacy against very wide range of insects, as well as having knock-down and long residual effect under different climate conditions.

In some embodiments, the combination provides a higher insecticidal activity than that envisaged on the basis of the sum of activities of each of the insecticides found therein. Such a combination allows the reduced dosages of the individual insecticides which can damage agriculturally important plants.

Thus, an enhanced insecticidal activity is observed when an insecticidal combination that comprises: (i) an anthranilamide compound of formula (I)

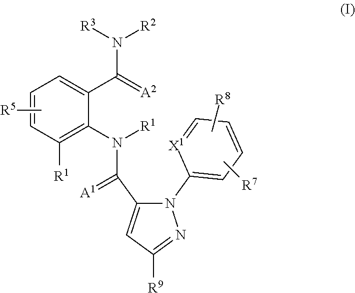

in which
A¹ and A² independently of one another represent oxygen or sulfur,
X¹ represents N or CR¹⁰,
R¹ represents hydrogen or represents C₁-C₆-alkyl, C₂-C₆-alkenyl, C₂-C₆-alkynyl or C₃-C₆-cycloalkyl, each of which is optionally mono- or polysubstituted, where the substituents independently of one another may be selected from the group consisting of R⁶, halogen, cyano, nitro, hydroxyl, C₁-C₄-alkoxy, C₁-C₄-alkylthio, C₁-C₄-alkylsulfinyl, C₁-C₄-alkylsulfonyl, C₂-C₄-alkoxycarbonyl, C₁-C₄-alkylamino, C₂-C₈-dialkylamino, C₃-C₆-cycloalkylamino, (C₁-C₄-alkyl)-C₃-C₆-cycloalkylamino and R¹¹,
R² represents hydrogen, C₁-C₆-alkyl, C₂-C₆-alkenyl, C₂-C₆-alkynyl, C₃-C₆-cycloalkyl, C₁-C₄-alkoxy, C₁-C₄-alkylamino, C₂-C₈-dialkylamino, C₃-C₆-cycloalkylamino, C₂-C₆-alkoxycarbonyl or C₂-C₆-alkylcarbonyl,
R³ represents hydrogen, R¹¹ or represents C₁-C₆-alkyl, C₂-C₆-alkenyl, C₂-C₆-alkynyl, C₃-C₆-cycloalkyl, each of which is optionally mono- or polysubstituted, where the substituents independently of one another may be selected from the group consisting of R⁶, halogen, cyano, nitro, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₂-C₆-alkoxycarbonyl, C₂-C₆-alkylcarbonyl, C₃-C₆-trialkylsilyl, R¹¹, phenyl, phenoxy and a 5- or 6-membered heteroaromatic ring, where each phenyl, phenoxy and 5- or 6-membered heteroaromatic ring may optionally be substituted and where the substituents independently of one another may be selected from one to three radicals W or one or more radicals R¹², or
R² and R³ may be attached to one another and form the ring M,
R⁴ represents hydrogen, C₁-C₆-alkyl, C₂-C₆-alkenyl, C₂-C₆-alkynyl, C₃-C₆-cycloalkyl, C₁-C₆-haloalkyl, C₂-C₆-haloalkenyl, C₂-C₆-haloalkynyl, C₃-C₆-halocycloalkyl, halogen, cyano, nitro, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl, C₁-C₄-alkylamino, C₂-C₈-dialkylamino, C₃-C₆-cycloalkylamino, C₃-C₆-trialkylsilyl or represents phenyl, benzyl or phenoxy, each of which is optionally mono- or polysubstituted, where the substituents independently of one another may be selected from the group consisting of C₁-C₄-alkyl, C₂-C₄-alkenyl, C₂-C₄-alkynyl, C₃-C₆-cycloalkyl, C₁-C₄-haloalkyl, C₂-C₄-haloalkenyl, C₂-C₄-haloalkynyl, C₃-C₆-halocycloalkyl, halogen, cyano, nitro, C₁-C₄-alkoxy, C₁-C₄-haloalkoxy, C₁-C₄-alkylthio, C₁-C₄-alkylsulfinyl, C₁-C₄-alkylsulfonyl, C₁-C₄-alkylamino, C₂-C₈-dialkylamino, C₃-C₆-cycloalkylamino, C₃-C₆-(alkyl)cycloalkylamino, C₂-C₄-alkylcarbonyl, C₂-C₆-alkoxycarbonyl, C₂-C₆-alkylaminocarbonyl, C₃-C₈-dialkylaminocarbonyl and C₃-C₆-trialkylsilyl,
R⁵ and R⁸ in each case independently of one another represent hydrogen, halogen or represent in each case optionally substituted C₁-C₄-alkyl, C₁-C₄-haloalkyl, R¹², G, J, —OJ, —OG, —S(O)ₚ-J, —S(O)ₚG, —S(O)ₚ-phenyl, where the substituents independently of one another may be selected from one to three radicals W or from the group consisting of R¹², C₁-C₁₀-alkyl, C₂-C₆-alkenyl, C₂-C₆-alkynyl, C₁-C₄-alkoxy and C₁-C₄-alkylthio, where each substituent may be substituted by one or more substituents independently of one another selected from the group consisting of G, J, R⁶, halogen, cyano, nitro, amino, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl, C₁-C₄-alkylamino, C₂-C₈-dialkylamino, C₃-C₆-trialkylsilyl, phenyl and phenoxy, where each phenyl or phenoxy ring may optionally be substituted and where the substituents independently of one another may be selected from one to three radicals W or one or more radicals R¹²,
G in each case independently of one another represents a 5- or 6-membered non-aromatic carbocyclic or heterocyclic ring which may optionally contain one or two ring members from the group consisting of C(═O), SO and S(═O)₂ and which may optionally be substituted by one to four substituents independently of one another selected from the group consisting of C₁-C₂-alkyl, halogen, cyano, nitro and C₁-C₂-alkoxy, or independently of one another represents C₂-C₆-alkenyl, C₂-C₆-alkynyl, C₃-C₇-cycloalkyl, (cyano)-C₃-C₇-cycloalkyl, (C₁-C₄-alkyl)-C₃-C₆-cycloalkyl, (C₃-C₆-cycloalkyl)-C₁-C₄-alkyl, where each cycloalkyl, (alkyl)cycloalkyl and (cycloalkyl)alkyl may optionally be substituted by one or more halogen atoms,
J in each case independently of one another represents an optionally substituted 5- or 6-membered heteroaromatic ring, where the substituents independently of one another may be selected from one to three radicals W or one or more radicals R¹²,
R⁶ independently of one another represents —C(=E¹)R¹⁹, -L(=E¹)R¹⁹, —C(=E¹)LR¹⁹, -LC(=E¹)LR¹⁹, —OP(=Q)(OR¹⁹)₂, —SO₂LR¹⁸ or -LSO₂LR¹⁹, where each E¹ independently of one another represents O, S, N—R¹⁵, N—OR¹⁵, N—N(R¹⁵)₂, N—S═O, N—CN or N—NO₂,
R⁷ represents hydrogen, C₁-C₄-alkyl, C₁-C₄-haloalkyl, halogen, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl,
R⁹ represents C₁-C₄-haloalkyl, C₁-C₄-haloalkoxy, C₁-C₄-haloalkylsulfinyl or halogen,
R¹⁰ represents hydrogen, C₁-C₄-alkyl, C₁-C₄-haloalkyl, halogen, cyano or C₁-C₄-haloalkoxy,
R¹¹ in each case independently of one another represents in each case optionally mono- to trisubstituted C₁-C₆-alkylthio, C₁-C₆-alkylsulfenyl, C₁-C₆-haloalkylthio, C₁-C₆-haloalkylsulfenyl, phenylthio or phenylsulfenyl, where the substituents independently of one another may be selected from the list W, —S(O)ₙN(R¹⁶)₂, —C(═O)R¹³, —L(C═O)R¹⁴, —S(C═O)LR¹⁴, —C(═O)LR¹³, —S(O)ₙNR¹³C(═O)R¹³, —S(O)ₙNR¹³C(═O)LR¹⁴ or —S(O)ₙNR¹³S(O)₂LR¹⁴,
L in each case independently of one another represents O, NR¹⁸ or S,
R¹² in each case independently of one another represents —B(OR¹⁷)₂, amino, SH, thiocyanato, C₃-C₈-trialkylsilyloxy, C₁-C₄-alkyl disulfides, —SF₅, —C(=E¹)R¹⁹, -LC(=E¹)R¹⁹, —C(=E¹)LR¹⁹, -LC(=E¹)LR¹⁹, —OP(=Q)(OR¹⁹)₂, —SO₂LR¹⁹ or -LSO₂LR¹⁹,
Q represents O or S,
R¹³ in each case independently of one another represents hydrogen or represents in each case optionally mono- or polysubstituted C₁-C₆-alkyl, C₂-C₆-alkenyl, C₂-C₆-alkynyl or C₃-C₆-cycloalkyl, where the substituents independently of one another may be selected from the group consisting of R⁶, halogen, cyano, nitro, hydroxyl, C₁-C₄-alkoxy, C₁-C₄-alkylsulfinyl, C₁-C₄-alkylsulfonyl, C₁-C₄-alkylamino, C₂-C₈-dialkylamino, C₃-C₆-cycloalkylamino or (C₁-C₄-alkyl)-C₃-C₆-cycloalkylamino,
R¹⁴ in each case independently of one another represents in each case optionally mono- or polysubstituted C₂-C₂₀-alkenyl, C₂-C₂₀-alkynyl or C₃-C₆-cycloalkyl, where the substituents independently of one another may be selected from the group consisting of R⁶, halogen, cyano, nitro, hydroxyl, C₁-C₄-alkoxy, C₁-C₄-alkylsulfinyl, C₁-C₄-alkylsulfonyl, C₁-C₄-alkylamino, C₂-C₈-dialkylamino, C₃-C₆-cycloalkylamino and (C₁-C₄-alkyl)-C₃-C₆-cycloalkylamino or represent optionally substituted phenyl, where the substituents independently of one another may be selected from one to three radicals W or one or more radicals R¹²,
R¹⁵ in each case independently of one another represents hydrogen or represents in each case optionally mono- or polysubstituted C₁-C₆-haloalkyl or C₁-C₆-alkyl, where the substituents independently of one another may be selected from the group consisting of cyano, nitro, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl, C₁-C₄-alkylamino, C₂-C₈-dialkylamino, C₂-C₆-alkoxycarbonyl, C₂-C₆-alkylcarbonyl, C₃-C₆-trialkylsilyl and optionally substituted phenyl, where the substituents independently of one another may be selected from one to three radicals W or one or more radicals R¹², or N(R¹⁵)₂ represents a cycle which forms the ring M,
R¹⁶ represents C₁-C₁₂-alkyl or C₁-C₁₂-haloalkyl, or N(R¹⁶)₂ represents a cycle which forms the ring M,
R¹⁷ in each case independently of one another represents hydrogen or C₁-C₄-alkyl, or B(OR¹⁷)₂ represents a ring in which the two oxygen atoms are attached via a chain having two to three carbon atoms which are optionally substituted by one or two substituents independently of one another selected from the group consisting of methyl and C₂-C₆-alkoxycarbonyl,
R¹⁸ in each case independently of one another represents hydrogen, C₁-C₆-alkyl or C₁-C₆-haloalkyl, or N(R¹³)(R¹⁸) represents a cycle which forms the ring M,
R¹⁹ in each case independently of one another represents hydrogen or represents in each case mono- or polysubstituted C₁-C₆-alkyl, where the substituents independently of one another may be selected from the group consisting of cyano, nitro, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl, C₁-C₄-alkylamino, C₂-C₈-dialkylamino, CO₂H, C₂-C₆-alkoxycarbonyl, C₂-C₆-alkylcarbonyl, C₃-C₆-trialkylsilyl and optionally substituted phenyl, where the substituents independently of one another may be selected from one to three radicals W, C₁-C₆-haloalkyl, C₃-C₆-cycloalkyl or phenyl or pyridyl, each of which is optionally mono- to trisubstituted by W,
M in each case represents an optionally mono- to tetrasubstituted ring which, in addition to the nitrogen atom attached to the substituent pair R¹³ and R¹⁸, (R¹⁵)₂ or (R¹⁶)₂, contains two to six carbon atoms and optionally additionally a further nitrogen, sulfur or oxygen atom, where the substituents independently of one another may be selected from the group consisting of C₁-C₂-alkyl, halogen, cyano, nitro and C₁-C₂-alkoxy,
W in each case independently of one another represents C₁-C₄-alkyl, C₂-C₄-alkenyl, C₂-C₄-alkynyl, C₃-C₆-cycloalkyl, C₁-C₄-haloalkyl, C₂-C₄-haloalkenyl, C₂-C₄-haloalkynyl, C₃-C₆-halocycloalkyl, halogen, cyano, nitro, C₁-C₄-alkoxy, C₁-C₄-haloalkoxy, C₁-C₄-alkylthio, C₁-C₄-alkylsulfonyl, C₁-C₄-alkylamino, C₂-C₈-dialkylamino, C₃-C₆-cycloalkylamino, (C₁-C₄-alkyl)-C₃-C₆-cycloalkylamino, C₂-C₄-alkylcarbonyl, C₂-C₆-alkoxycarbonyl, CO₂H, C₂-C₆-alkylaminocarbonyl, C₃-C₈-dialkylaminocarbonyl or C₃-C₆-trialkylsilyl,
n in each case independently of one another represents 0 or 1,
p in each case independently of one another represents 0, 1 or 2,
where, if (a) R⁵ represents hydrogen, C₁-C₆-alkyl, C₁-C₆-haloalkyl, C₂-C₆-haloalkenyl, C₂-C₆-haloalkynyl, C₁-C₄-haloalkoxy, C₁-C₄-haloalkylthio or halogen and (b) R⁸ represents hydrogen, C₁-C₆-alkyl, C₁-C₆-haloalkyl, C₂-C₆-haloalkenyl, C₂-C₆-haloalkynyl, C₁-C₄-haloalkoxy, C₁-C₄-haloalkylthio, halogen, C₂-C₄-alkylcarbonyl, C₂-C₆-alkoxycarbonyl, C₂-C₆-alkylaminocarbonyl or C₃-C₈ dialkylaminocarbonyl, (c) at least one substituent selected from the group consisting of R⁶, R¹¹ and R¹² if present and (d) if R¹² is not present, at least one of the radicals R⁶ and R¹¹ is different from C₂-C₆-alkylcarbonyl, C₂-C₆-alkoxycarbonyl, C₂-C₆-alkylaminocarbonyl and C₃-C₈-dialkylaminocarbonyl, and where the compound of the general formula (I) may also be an N-oxide or salt;
and (ii) tau-fluvalinate, is used for the control of insects.

In some embodiments, the enhanced activity is synergistic.

In some embodiments, the combination is an improved combination in that the amount of the tau fluvalinate and/or the amount of the anthranilamide compound of formula (I) are more effective for controlling chewing pests than when the amount of the tau fluvalinate and the amount of the anthranilamide compound of formula (I) are applied alone.

In some embodiments, the combination is an improved combination in that the amount of the tau fluvalinate is more effective for treating a plant or locus against fungal infection when applied in combination with the amount of the anthranilamide compound of formula (I) than when the same amount of the tau fluvalinate is applied not in combination with the same amount of the anthranilamide compound of formula (I).

In some embodiments, the combination is an improved combination in that the amount of the anthranilamide compound of formula (I) improves the insecticidal efficacy of the amount of the tau fluvalinate compared to when the same amount of the tau fluvalinate is applied not in combination with the amount of the anthranilamide compound of formula (I).

In some embodiments, insecticidal efficacy is increased by at least 10%, 20%, 30% or 40% compared to when the same amount of the tau fluvalinate is applied alone. In some embodiments, insecticidal efficacy is increased by at least 50%, 100%, 200% or 300% compared to when the same amount of the tau fluvalinate is applied alone.

In some embodiments, the combination is an improved combination in that the amount of the anthranilamide compound of formula (I) is effective to increase sensitivity of the insect to the amount of the tau fluvalinate compared to the sensitivity of the insect to the amount of the tau fluvalinate when it is applied not in combination with the amount of the anthranilamide compound of formula (I).

In some embodiments, the combination is an improved combination in that it prolongs the period of protection against insect infection and/or control of insect infection than when the amount of the anthranilamide compound of formula (I) and the amount of a tau fluvalinate are applied alone.

In some embodiments, the period of protection against insect infection and/or control of insect infection is prolonged by at least 7 days, 14 day, 21 days, or 28 days.

In some embodiments, the combination is an improved combination in that it reduces the amount of time needed to achieve a level of insect control compared to when the amount of the anthranilamide compound of formula (I) and the amount of a tau fluvalinate are applied alone.

In some embodiments, the amount of tau fluvalinate needed to achieve a level of insect control in the presence of the anthranilamide compound of formula (I), is reduced by at least 50%, 60%, 70%, 80% or 90%, compared to the amount of tau fluvalinate when applied alone.

In one embodiment, the anthranilamide compound of formula (I) is chlorantrniliprole, cyantraniliprole, tetraniliprole, tetrachlorantraniliprole, bromantraniliprole, and cyclaniliprole.

In a specific embodiment, the anthranilamide compound of formula (I) is chlorantraniliprole.

The weight ratio between the anthranilamide compound of formula (I), and tau-fluvalinate cannot generally be defined, as it varies depending upon various conditions such as the type of the formulation, weather conditions, the type of crop and the type of pests.

In one embodiment, the weight ratio of the anthranilamide compound of formula (I) to the tau-fluvalinate is from about 1:3000 to 3000:1. In one embodiment, the weight ratio of the anthranilamide compound of formula (I) to the tau-fluvalinate is from about 1:2000 to 2000:1. In one embodiment, the weight ratio of the anthranilamide compound of formula (I) to the tau-fluvalinate is from about 1:1000 to 1000:1. In one embodiment, the weight ratio of the anthranilamide compound of formula (I) to the tau-fluvalinate is from about 1:500 to 500:1. In one embodiment, the weight ratio of the anthranilamide compound of formula (I) to the tau-fluvalinate is from about 1:200 to 200:1. In one embodiment, the weight ratio of the anthranilamide compound of formula (I) to the tau-fluvalinate is from about 1:100 to 100:1. In one embodiment, the weight ratio of the anthranilamide compound of formula (I) to the tau-fluvalinate is from about 1:10 to 10:1. In one embodiment, the weight ratio of the anthranilamide compound of formula (I) to the tau-fluvalinate is from about 1:2000 to 1:1. In one embodiment, the weight ratio of the anthranilamide compound of formula (I) to the tau-fluvalinate is from about 1:1000 to 1:1. In one embodiment, the weight ratio of the anthranilamide compound of formula (I) to the tau-fluvalinate is from about 1:750 to 1:1. In one embodiment, the weight ratio of the anthranilamide compound of formula (I) to the tau-fluvalinate is from about 1:500 to 1:1. In one embodiment, the weight ratio of the anthranilamide compound of formula (I) to the tau-fluvalinate is from about 1:200 to 1:1. In one embodiment, the weight ratio of the anthranilamide compound of formula (I) to the tau-fluvalinate is from about 1:100 to 1:1. In one embodiment, the weight ratio of the anthranilamide compound of formula (I) to the tau-fluvalinate is from about 1:50 to 1:1. In one embodiment, the weight ratio of the anthranilamide compound of formula (I) to the tau-fluvalinate is from about 1:40 to 1:1. In one embodiment, the weight ratio of the anthranilamide compound of formula (I) to the tau-fluvalinate is from about 1:30 to 1:1. In one embodiment, the weight ratio of the anthranilamide compound of formula (I) to the tau-fluvalinate is from about 1:20 to 1:1. In one embodiment, the weight ratio of the anthranilamide compound of formula (I) to the tau-fluvalinate is from about 1:10 to 1:1. In one embodiment, the weight ratio of the anthranilamide compound of formula (I) to the tau-fluvalinate is from about 1:5 to 1:1. In one embodiment, the weight ratio of the anthranilamide compound of formula (I) to the tau-fluvalinate is from about 1:4 to 1:1. In one embodiment, the weight ratio of the anthranilamide compound of formula (I) to the tau-fluvalinate is from about 1:3 to 1:1. In one embodiment, the weight ratio of the anthranilamide compound of formula (I) to the tau-fluvalinate is from about 1:2 to 1:1. In one embodiment, the weight ratio of the anthranilamide compound of formula (I) to the tau-fluvalinate is about 1:3.2. In one embodiment, the weight ratio of the anthranilamide compound of formula (I) to the tau-fluvalinate is about 1:4. In one embodiment, the weight ratio of the anthranilamide compound of formula (I) to the tau-fluvalinate is about 1:1.3. In one embodiment, the weight ratio of the anthranilamide compound of formula (I) to the tau-fluvalinate is about 1:1.7.

In one embodiment, the weight ratio of the chlorantraniliprole to tau-fluvalinate is from about 1:3000 to 3000:1. In one embodiment, the weight ratio of the chlorantraniliprole to the tau-fluvalinate is from about 1:2000 to 2000:1. In one embodiment, the weight ratio of the chlorantraniliprole to the tau-fluvalinate is from about 1:1000 to 1000:1. In one embodiment, the weight ratio of the chlorantraniliprole to the tau-fluvalinate is from about 1:500 to 500:1. In one embodiment, the weight ratio of the chlorantraniliprole to the tau-fluvalinate is from about 1:200 to 200:1. In one embodiment, the weight ratio of the chlorantraniliprole to the tau-fluvalinate is from about 1:100 to 100:1. In one embodiment, the weight ratio of the chlorantraniliprole to the tau-fluvalinate is from about 1:10 to 10:1. In one embodiment, the weight ratio of the chlorantraniliprole to the tau-fluvalinate is from about 1:2000 to 1:1. In one embodiment, the weight ratio of the chlorantraniliprole to the tau-fluvalinate is from about 1:1000 to 1:1. In one embodiment, the weight ratio of the chlorantraniliprole to the tau-fluvalinate is from about 1:750 to 1:1. In one embodiment, the weight ratio of the chlorantraniliprole to the tau-fluvalinate is from about 1:500 to 1:1. In one embodiment, the weight ratio of the chlorantraniliprole to the tau-fluvalinate is from about 1:200 to 1:1. In one embodiment, the weight ratio of the chlorantraniliprole to the tau-fluvalinate is from about 1:100 to 1:1. In one embodiment, the weight ratio of the chlorantraniliprole to the tau-fluvalinate is from about 1:50 to 1:1. In one embodiment, the weight ratio of the chlorantraniliprole to the tau-fluvalinate is from about 1:40 to 1:1. In one embodiment, the weight ratio of the chlorantraniliprole to the tau-fluvalinate is from about 1:30 to 1:1. In one embodiment, the weight ratio of the chlorantraniliprole to the tau-fluvalinate is from about 1:20 to 1:1. In one embodiment, the weight ratio of the chlorantraniliprole to the tau-fluvalinate is from about 1:10 to 1:1. In one embodiment, the weight ratio of the chlorantraniliprole to the tau-fluvalinate is from about 1:5 to 1:1. In one embodiment, the weight ratio of the chlorantraniliprole to the tau-fluvalinate is from about 1:4 to 1:1. In one embodiment, the weight ratio of the chlorantraniliprole to the tau-fluvalinate is from about 1:3 to 1:1. In one embodiment, the weight ratio of the chlorantraniliprole to the tau-fluvalinate is from about 1:2 to 1:1. In one embodiment, the weight ratio of the chlorantraniliprole to the tau-fluvalinate is about 1:3.2. In one embodiment, the weight ratio of the chlorantraniliprole to the tau-fluvalinate is about 1:4. In one embodiment, the weight ratio of the chlorantraniliprole to the tau-fluvalinate is about 1:1.3. In one embodiment, the weight ratio of the chlorantraniliprole to the tau-fluvalinate is about 1:1.7.

In one embodiment, the weight ratio of the cyantraniliprole to tau-fluvalinate is from about 1:3000 to 3000:1. In one embodiment, the weight ratio of the cyantraniliprole to the tau-fluvalinate is from about 1:2000 to 2000:1. In one embodiment, the weight ratio of the cyantraniliprole to the tau-fluvalinate is from about 1:1000 to 1000:1. In one embodiment, the weight ratio of the cyantraniliprole to the tau-fluvalinate is from about 1:500 to 500:1. In one embodiment, the weight ratio of the cyantraniliprole to the tau-fluvalinate is from about 1:200 to 200:1. In one embodiment, the weight ratio of the cyantraniliprole to the tau-fluvalinate is from about 1:100 to 100:1. In one embodiment, the weight ratio of the cyantraniliprole to the tau-fluvalinate is from about 1:10 to 10:1. In one embodiment, the weight ratio of the cyantraniliprole to the tau-fluvalinate is from about 1:2000 to 1:1. In one embodiment, the weight ratio of the cyantraniliprole to the tau-fluvalinate is from about 1:1000 to 1:1. In one embodiment, the weight ratio of the cyantraniliprole to the tau-fluvalinate is from about 1:750 to 1:1. In one embodiment, the weight ratio of the cyantraniliprole to the tau-fluvalinate is from about 1:500 to 1:1. In one embodiment, the weight ratio of the cyantraniliprole to the tau-fluvalinate is from about 1:200 to 1:1. In one embodiment, the weight ratio of the cyantraniliprole to the tau-fluvalinate is from about 1:100 to 1:1. In one embodiment, the weight ratio of the cyantraniliprole to the tau-fluvalinate is from about 1:50 to 1:1. In one embodiment, the weight ratio of the cyantraniliprole to the tau-fluvalinate is from about 1:40 to 1:1. In one embodiment, the weight ratio of the cyantraniliprole to the tau-fluvalinate is from about 1:30 to 1:1. In one embodiment, the weight ratio of the cyantraniliprole to the tau-fluvalinate is from about 1:20 to 1:1. In one embodiment, the weight ratio of the cyantraniliprole to the tau-fluvalinate is from about 1:10 to 1:1. In one embodiment, the weight ratio of the cyantraniliprole to the tau-fluvalinate is from about 1:5 to 1:1. In one embodiment, the weight ratio of the cyantraniliprole to the tau-fluvalinate is from about 1:4 to 1:1. In one embodiment, the weight ratio of the cyantraniliprole to the tau-fluvalinate is from about 1:3 to 1:1. In one embodiment, the weight ratio of the cyantraniliprole to the tau-fluvalinate is from about 1:2 to 1:1. In one embodiment, the weight ratio of the cyantraniliprole to the tau-fluvalinate is about 1:3.2. In one embodiment, the weight ratio of the cyantraniliprole to the tau-fluvalinate is about 1:4. In one embodiment, the weight ratio of the cyantraniliprole to the tau-fluvalinate is about 1:1.3. In one embodiment, the weight ratio of the cyantraniliprole to the tau-fluvalinate is about 1:1.7.

In one embodiment, the weight ratio of the tetraniliprole to tau-fluvalinate is from about 1:3000 to 3000:1. In one embodiment, the weight ratio of the tetraniliprole to the tau-fluvalinate is from about 1:2000 to 2000:1. In one embodiment, the weight ratio of the tetraniliprole to the tau-fluvalinate is from about 1:1000 to 1000:1. In one embodiment, the weight ratio of the tetraniliprole to the tau-fluvalinate is from about 1:500 to 500:1. In one embodiment, the weight ratio of the tetraniliprole to the tau-fluvalinate is from about 1:200 to 200:1. In one embodiment, the weight ratio of the tetraniliprole to the tau-fluvalinate is from about 1:100 to 100:1. In one embodiment, the weight ratio of the tetraniliprole to the tau-fluvalinate is from about 1:10 to 10:1. In one embodiment, the weight ratio of the tetraniliprole to the tau-fluvalinate is from about 1:2000 to 1:1. In one embodiment, the weight ratio of the tetraniliprole to the tau-fluvalinate is from about 1:1000 to 1:1. In one embodiment, the weight ratio of the tetraniliprole to the tau-fluvalinate is from about 1:750 to 1:1. In one embodiment, the weight ratio of the tetraniliprole to the tau-fluvalinate is from about 1:500 to 1:1. In one embodiment, the weight ratio of the tetraniliprole to the tau-fluvalinate is from about 1:200 to 1:1. In one embodiment, the weight ratio of the tetraniliprole to the tau-fluvalinate is from about 1:100 to 1:1. In one embodiment, the weight ratio of the tetraniliprole to the tau-fluvalinate is from about 1:50 to 1:1. In one embodiment, the weight ratio of the tetraniliprole to the tau-fluvalinate is from about 1:40 to 1:1. In one embodiment, the weight ratio of the tetraniliprole to the tau-fluvalinate is from about 1:30 to 1:1. In one embodiment, the weight ratio of the tetraniliprole to the tau-fluvalinate is from about 1:20 to 1:1. In one embodiment, the weight ratio of the tetraniliprole to the tau-fluvalinate is from about 1:10 to 1:1. In one embodiment, the weight ratio of the tetraniliprole to the tau-fluvalinate is from about 1:5 to 1:1. In one embodiment, the weight ratio of the tetraniliprole to the tau-fluvalinate is from about 1:4 to 1:1. In one embodiment, the weight ratio of the tetraniliprole to the tau-fluvalinate is from about 1:3 to 1:1. In one embodiment, the weight ratio of the tetraniliprole to the tau-fluvalinate is from about 1:2 to 1:1. In one embodiment, the weight ratio of the tetraniliprole to the tau-fluvalinate is about 1:3.2. In one embodiment, the weight ratio of the tetraniliprole to the tau-fluvalinate is about 1:4. In one embodiment, the weight ratio of the tetraniliprole to the tau-fluvalinate is about 1:1.3. In one embodiment, the weight ratio of the tetraniliprole to the tau-fluvalinate is about 1:1.7.

In one embodiment, the weight ratio of the tetrachlorantraniliprole to tau-fluvalinate is from about 1:3000 to 3000:1. In one embodiment, the weight ratio of the tetrachlorantraniliprole to the tau-fluvalinate is from about 1:2000 to 2000:1. In one embodiment, the weight ratio of the tetrachlorantraniliprole to the tau-fluvalinate is from about 1:1000 to 1000:1. In one embodiment, the weight ratio of the tetrachlorantraniliprole to the tau-fluvalinate is from about 1:500 to 500:1. In one embodiment, the weight ratio of the tetrachlorantraniliprole to the tau-fluvalinate is from about 1:200 to 200:1. In one embodiment, the weight ratio of the tetrachlorantraniliprole to the tau-fluvalinate is from about 1:100 to 100:1. In one embodiment, the weight ratio of the tetrachlorantraniliprole to the tau-fluvalinate is from about 1:10 to 10:1. In one embodiment, the weight ratio of the tetrachlorantraniliprole to the tau-fluvalinate is from about 1:2000 to 1:1. In one embodiment, the weight ratio of the tetrachlorantraniliprole to the tau-fluvalinate is from about 1:1000 to 1:1. In one embodiment, the weight ratio of the tetrachlorantraniliprole to the tau-fluvalinate is from about 1:750 to 1:1. In one embodiment, the weight ratio of the tetrachlorantraniliprole to the tau-fluvalinate is from about 1:500 to 1:1. In one embodiment, the weight ratio of the tetrachlorantraniliprole to the tau-fluvalinate is from about 1:200 to 1:1. In one embodiment, the weight ratio of the tetrachlorantraniliprole to the tau-fluvalinate is from about 1:100 to 1:1. In one embodiment, the weight ratio of the tetrachlorantraniliprole to the tau-fluvalinate is from about 1:50 to 1:1. In one embodiment, the weight ratio of the tetrachlorantraniliprole to the tau-fluvalinate is from about 1:40 to 1:1. In one embodiment, the weight ratio of the tetrachlorantraniliprole to the tau-fluvalinate is from about 1:30 to 1:1. In one embodiment, the weight ratio of the tetrachlorantraniliprole to the tau-fluvalinate is from about 1:20 to 1:1. In one embodiment, the weight ratio of the tetrachlorantraniliprole to the tau-fluvalinate is from about 1:10 to 1:1. In one embodiment, the weight ratio of the tetrachlorantraniliprole to the tau-fluvalinate is from about 1:5 to 1:1. In one embodiment, the weight ratio of the tetrachlorantraniliprole to the tau-fluvalinate is from about 1:4 to 1:1. In one embodiment, the weight ratio of the tetrachlorantraniliprole to the tau-fluvalinate is from about 1:3 to 1:1. In one embodiment, the weight ratio of the tetrachlorantraniliprole to the tau-fluvalinate is from about 1:2 to 1:1. In one embodiment, the weight ratio of the tetrachlorantraniliprole to the tau-fluvalinate is about 1:3.2. In one embodiment, the weight ratio of the tetrachlorantraniliprole to the tau-fluvalinate is about 1:4. In one embodiment, the weight ratio of the tetrachlorantraniliprole to the tau-fluvalinate is about 1:1.3. In one embodiment, the weight ratio of the tetrachlorantraniliprole to the tau-fluvalinate is about 1:1.7.

In one embodiment, the weight ratio of the bromantraniliprole to tau-fluvalinate is from about 1:3000 to 3000:1. In one embodiment, the weight ratio of the bromantraniliprole to the tau-fluvalinate is from about 1:2000 to 2000:1. In one embodiment, the weight ratio of the bromantraniliprole to the tau-fluvalinate is from about 1:1000 to 1000:1. In one embodiment, the weight ratio of the bromantraniliprole to the tau-fluvalinate is from about 1:500 to 500:1. In one embodiment, the weight ratio of the bromantraniliprole to the tau-fluvalinate is from about 1:200 to 200:1. In one embodiment, the weight ratio of the bromantraniliprole to the tau-fluvalinate is from about 1:100 to 100:1. In one embodiment, the weight ratio of the bromantraniliprole to the tau-fluvalinate is from about 1:10 to 10:1. In one embodiment, the weight ratio of the bromantraniliprole to the tau-fluvalinate is from about 1:2000 to 1:1. In one embodiment, the weight ratio of the bromantraniliprole to the tau-fluvalinate is from about 1:1000 to 1:1. In one embodiment, the weight ratio of the bromantraniliprole to the tau-fluvalinate is from about 1:750 to 1:1. In one embodiment, the weight ratio of the bromantraniliprole to the tau-fluvalinate is from about 1:500 to 1:1. In one embodiment, the weight ratio of the bromantraniliprole to the tau-fluvalinate is from about 1:200 to 1:1. In one embodiment, the weight ratio of the bromantraniliprole to the tau-fluvalinate is from about 1:100 to 1:1. In one embodiment, the weight ratio of the bromantraniliprole to the tau-fluvalinate is from about 1:50 to 1:1. In one embodiment, the weight ratio of the bromantraniliprole to the tau-fluvalinate is from about 1:40 to 1:1. In one embodiment, the weight ratio of the bromantraniliprole to the tau-fluvalinate is from about 1:30 to 1:1. In one embodiment, the weight ratio of the bromantraniliprole to the tau-fluvalinate is from about 1:20 to 1:1. In one embodiment, the weight ratio of the bromantraniliprole to the tau-fluvalinate is from about 1:10 to 1:1. In one embodiment, the weight ratio of the bromantraniliprole to the tau-fluvalinate is from about 1:5 to 1:1. In one embodiment, the weight ratio of the bromantraniliprole to the tau-fluvalinate is from about 1:4 to 1:1. In one embodiment, the weight ratio of the bromantraniliprole to the tau-fluvalinate is from about 1:3 to 1:1. In one embodiment, the weight ratio of the bromantraniliprole to the tau-fluvalinate is from about 1:2 to 1:1. In one embodiment, the weight ratio of the bromantraniliprole to the tau-fluvalinate is about 1:3.2. In one embodiment, the weight ratio of the bromantraniliprole to the tau-fluvalinate is about 1:4. In one embodiment, the weight ratio of the bromantraniliprole to the tau-fluvalinate is about 1:1.3. In one embodiment, the weight ratio of the bromantraniliprole to the tau-fluvalinate is about 1:1.7.

In one embodiment, the weight ratio of the cyclaniliprole to tau-fluvalinate is from about 1:3000 to 3000:1. In one embodiment, the weight ratio of the cyclaniliprole to the tau-fluvalinate is from about 1:2000 to 2000:1. In one embodiment, the weight ratio of the cyclaniliprole to the tau-fluvalinate is from about 1:1000 to 1000:1. In one embodiment, the weight ratio of the cyclaniliprole to the tau-fluvalinate is from about 1:500 to 500:1. In one embodiment, the weight ratio of the cyclaniliprole to the tau-fluvalinate is from about 1:200 to 200:1. In one embodiment, the weight ratio of the cyclaniliprole to the tau-fluvalinate is from about 1:100 to 100:1. In one embodiment, the weight ratio of the cyclaniliprole to the tau-fluvalinate is from about 1:10 to 10:1. In one embodiment, the weight ratio of the cyclaniliprole to the tau-fluvalinate is from about 1:2000 to 1:1. In one embodiment, the weight ratio of the cyclaniliprole to the tau-fluvalinate is from about 1:1000 to 1:1. In one embodiment, the weight ratio of the cyclaniliprole to the tau-fluvalinate is from about 1:750 to 1:1. In one embodiment, the weight ratio of the cyclaniliprole to the tau-fluvalinate is from about 1:500 to 1:1.

In one embodiment, the weight ratio of the cyclaniliprole to the tau-fluvalinate is from about 1:200 to 1:1. In one embodiment, the weight ratio of the cyclaniliprole to the tau-fluvalinate is from about 1:100 to 1:1. In one embodiment, the weight ratio of the cyclaniliprole to the tau-fluvalinate is from about 1:50 to 1:1. In one embodiment, the weight ratio of the cyclaniliprole to the tau-fluvalinate is from about 1:40 to 1:1. In one embodiment, the weight ratio of the cyclaniliprole to the tau-fluvalinate is from about 1:30 to 1:1. In one embodiment, the weight ratio of the cyclaniliprole to the tau-fluvalinate is from about 1:20 to 1:1. In one embodiment, the weight ratio of the cyclaniliprole to the tau-fluvalinate is from about 1:10 to 1:1. In one embodiment, the weight ratio of the cyclaniliprole to the tau-fluvalinate is from about 1:5 to 1:1. In one embodiment, the weight ratio of the cyclaniliprole to the tau-fluvalinate is from about 1:4 to 1:1. In one embodiment, the weight ratio of the cyclaniliprole to the tau-fluvalinate is from about 1:3 to 1:1. In one embodiment, the weight ratio of the cyclaniliprole to the tau-fluvalinate is from about 1:2 to 1:1. In one embodiment, the weight ratio of the cyclaniliprole to the tau-fluvalinate is about 1:3.2. In one embodiment, the weight ratio of the cyclaniliprole to the tau-fluvalinate is about 1:4. In one embodiment, the weight ratio of the cyclaniliprole to the tau-fluvalinate is about 1:1.3. In one embodiment, the weight ratio of the cyclaniliprole to the tau-fluvalinate is about 1:1.7.

Application of the inventive compositions to plants may also lead to an increase in the crop yield.

In an embodiment, the insecticidal combination of the present subject matter may be applied pre-sowing or post-sowing, pre-emergence, or early-post-emergence of the crop. The herbicidal combination may be applied via in furrow spray, foliar application, broadcast, basal application, soil application, soil incorporation or soil injection.

In a further embodiment, the combination is applied in non-crop areas which include but are not limited to, commercial areas, residential areas, lawns, ornamental plants, shrubs, trees, parks, livestock areas, warehouses, food storage facilities, grain bins, turfgrass, pastures, grasslands, rangelands, fallow land, rights-of-way, golf courses, parks, along roadsides, power-lines, pipelines, railways, forests, well sites, and equipment yards.

In yet another embodiment, the plants include vegetables, such as tomatoes, peppers, cabbage, broccoli, lettuce, spinach, cauliflower, cucurbits, melon, watermelon, cucumbers, carrots, onions, potatoes, tobacco, pome and stone fruits, walnuts, kiwi, berries, olive, almonds, pineapples, apples, pears, plums, peaches, and cherries, table and wine grapes, citrus fruit, such as oranges, lemons, grapefruits and limes, cotton, soybean, oil seed rape, tree nuts, wheat, barley, maize, sorghum, sunflower, peanuts, rice, pasture, corn, coffee, beans, peas, yucca, sugar cane, clover, chili and ornamentals such as roses.

In still another embodiment, the plants include cultivated plants which tolerate the action of herbicides, fungicides or insecticides as a result of breeding and/or genetically engineered methods.

In another embodiment, the insect pests are of the order Coleoptera, such as Acanthoscelides spp. (weevils), Acanthoscelides obtectus (common bean weevil), Agrilus planipennis (emerald ash borer), Agriotes spp. (wireworms), Anoplophora glabripennis (Asian longhorned beetle), Anthonomus spp. (weevils), Anthonomus grandis (boll weevil), Aphidius spp., Apion spp. (weevils), Apogonia spp. (grubs), Ataenius spretulus (Black Turgrass Ataenius), Atomaria linearis (pygmy mangold beetle), Aulacophore spp., Bothynoderes punctiventris (beet root weevil), Bruchus spp. (weevils), Bruchus pisorum (pea weevil), Cacoesia spp., Callosobruchus maculatus (southern cow pea weevil), Carpophilus hemipteras (dried fruit beetle), Cassida vittata, Cerosterna spp, Cerotoma spp. (chrysomeids), Cerotoma trifurcata (bean leaf beetle), Ceutorhynchus spp. (weevils), Ceutorhynchus assimilis (cabbage seedpod weevil), Ceutorhynchus napi (cabbage curculio), Chaetocnema spp. (chrysomelids), Colaspis spp. (soil beetles), Conoderus scalaris, Conoderus stigmosus, Conotrachelus nenuphar (plum curculio), Cotinus nitidis (Green June beetle), Crioceris asparagi (asparagus beetle), Cryptolestes ferrugineus (rusty grain beetle), Cryptolestes pusillus (flat grain beetle), Cryptolestes turcicus (Turkish grain beetle), Ctenicera spp. (wireworms), Curculio spp. (weevils), Cyclocephala spp. (grubs), Cylindrocpturus adspersus (sunflower stem weevil), Deporaus marginatus (mango leaf-cutting weevil), Dermestes lardarius (larder beetle), Dermestes maculates (hide beetle), Diabrotica spp. (chrysolemids), Epilachna varivestis (Mexican bean beetle), Faustinus cubae, Hylobius pales (pales weevil), Hypera spp. (weevils), Hypera postica (alfalfa weevil), Hyperdoes spp. (Hyperodes weevil), Hypothenemus hampei (coffee berry beetle), Ips spp. (engravers), Lasioderma serricorne (cigarette beetle), Leptinotarsa decemlineata (Colorado potato beetle), Liogenys futscus, Liogenys suturalis, Lissorhoptrus oryzophilus (rice water weevil), Lyctus spp. (wood beetles/powder post beetles), Maecolaspis joliveti, Megascelis spp., Melanotus communis, Meligethes spp., Meligethes aeneus (blossom beetle), Melolontha (common European cockchafer), Oberea brevis, Oberea linearis, Oryctes rhinoceros (date palm beetle), Oryzaephilus mercator (merchant grain beetle), Oryzaephilus surinamensis (sawtoothed grain beetle), Otiorhynchus spp. (weevils), Oulema melanopus (cereal leaf beetle), Oulema oryzae, Pantomorus spp. (weevils), Phyllophaga spp. (May/June beetle), Phyllophaga cuyabana, Phyllotreta spp. (chrysomelids), Phynchites spp., Popillia japonica (Japanese beetle), Prostephanus truncates (larger grain borer), Rhizopertha dominica (lesser grain borer), Rhizotrogus spp. (Eurpoean chafer), Rhynchophorus spp. (weevils), Scolytus spp. (wood beetles), Shenophorus spp. (Billbug), Sitona lineatus (pea leaf weevil), Sitophilus spp. (grain weevils), Sitophilus granaries (granary weevil), Sitophilus oryzae (rice weevil), Stegobium paniceum (drugstore beetle), Tribolium spp. (flour beetles), Tribolium castaneum (red flour beetle), Tribolium confusum (confused flour beetle), Trogoderma variabile (warehouse beetle) and Zabrus tenebioides.

In yet another embodiment, the insect pests are of the order Diptera, such as Aedes spp. (mosquitoes), Agromyza frontella (alfalfa blotch leafminer), Agromyza spp. (leaf miner flies), Anastrepha spp. (fruit flies), Anastrepha suspensa (Caribbean fruit fly), Anopheles spp. (mosquitoes), Batrocera spp. (fruit flies), Bactrocera cucurbitae (melon fly), Bactrocera dorsalis (oriental fruit fly), Ceratitis spp. (fruit flies), Ceratitis capitata (Mediterranea fruit fly), Chrysops spp. (deer flies), Cocliliomyia spp. (screwworms), Contarinia spp. (Gall midges), Culex spp. (mosquitoes), Dasineura spp. (gall midges), Dasineura brassicae (cabbage gall midge), Delia spp., Delia platura (seedcorn maggot), Drosophila spp. (vinegar flies), Fannia spp. (filth flies), Fannia canicularis (little house fly), Fannia scalaris (latrine fly), Gasterophilus intestinalis (horse bot fly), Gracillia perseae, Haematobia irritans (horn fly), Hylemyia spp. (root maggots), Hypoderma lineatum (common cattle grub), Liriomyza spp. (leafminerflies), Liriomyza brassica (serpentine leafminer), Melophagus ovinus (sheep ked), Musca spp. (muscid flies), Musca autumnalis (face fly), Musca domestica (house fly), Oestrus ovis (sheep bot fly), Oscinella frit (grass fly), Pegomyia betae (beet leafminer), Phorbia spp., Psila rosae (carrot rust fly), Rhagoletis cerasi (cherry fruit fly), Rhagoletis pomonella (apple maggot), Sitodiplosis mosellana (orange wheat blossom midge), Stomoxys calcitrans (stable fly), Tabanus spp. (horse flies) and Tipula spp. (crane flies).

In yet another embodiment, the insect pests are of the order Hemiptera, such as Acrosternum hilare (green stink bug), Blissus leucopterus (chinch bug), Calocoris norvegicus (potato mirid), Cimex hemipterus (tropical bed bug), Cimex lectularius (bed bug), Dagbertus fasciatus, Dichelops furcatus, Dysdercus suturellus (cotton stainer), Edessa meditabunda, Eurygaster maura (cereal bug), Euschistus heros, Euschistus servus (brown stink bug), Helopeltis antonii, Helopeltis theivora (tea blight plantbug), Lagynotomus spp. (stink bugs), Leptocorisa oratorius, Leptocorisa varicornis, Lygus spp. (plant bugs), Lygus hesperus (western tarnished plant bug), Maconellicoccus hirsutus, Neurocolpus longirostris, Nezara viridula (southern green stink bug), Paratrioza cockerelli, Phytocoris spp. (plant bugs), Phytocoris californicus, Phytocoris relativus, Piezodorus guildingi, Poecilocapsus lineatus (fourlined plant bug), Psallus vaccinicola, Pseudacysta perseae, Scaptocoris castanea and Triatoma spp. (bloodsucking conenose bugs/kissing bugs).

In yet another embodiment, the insect pests are of the order Homoptera, such as Acrythosiphon pisum (pea aphid), Adelges spp. (adelgids), Aleurodes proletella (cabbage whitefly), Aleurodicus disperses, Aleurothrixus floccosus (woolly whitefly), Aluacaspis spp., Amrasca bigutella, Aphrophora spp. (leafhoppers), Aonidiella aurantii (California red scale), Aphis spp. (aphids), Aphis gossypii (cotton aphid), Aphis pomi (apple aphid), Aulacorthum solani (foxglove aphid), Bemisia spp. (whiteflies), Bemisia argentifolii, Bemisia tabaci (sweetpotato whitefly), Brachycolus noxius (Russian aphid), Brachycorynella asparagi (asparagus aphid), Brevennia rehi, Brevicoryne brassicae (cabbage aphid), Ceroplastes spp. (scales), Ceroplastes rubens (red wax scale), Chionaspis spp. (scales), Chrysomphalus spp. (scales), Coccus spp. (scales), Dysaphis plantaginea (rosy apple aphid), Empoasca spp. (leafhoppers), Eriosoma lanigerum (woolly apple aphid), Icerya purchasi (cottony cushion scale), Idioscopus nitidulus (mango leafhopper), Laodelphax striatellus (smaller brown planthopper), Lepidosaphes spp., Macrosiphum spp., Macrosiphum euphorbiae (potato aphid), Macrosiphum granarium (English grain aphid), Macrosiphum rosae (rose aphid), Macrosteles quadrilineatus (aster leafhopper), Mahanarva frimbiolata, Metopolophium dirhodum (rose grain aphid), Mictis longicornis, Myzus persicae (green peach aphid), Nephotettix spp. (leafhoppers), Nephotettix cinctipes (green leafhopper), Nilaparvata lugens (brown planthopper), Parlatoria pergandii (chaff scale), Parlatoria ziziphi (ebony scale), Peregrinus maidis (corn delphacid), Philaenus spp. (spittlebugs), Phylloxera vitifoliae (grape phylloxera), Physokermes piceae (spruce bud scale), Planococcus spp. (mealybugs), Pseudococcus spp. (mealybugs), Pseudococcus brevipes (pine apple mealybug), Quadraspidiotus perniciosus (San Jose scale), Rhapalosiphum spp. (aphids), Rhapalosiphum maida (corn leaf aphid), Rhapalosiphum padi (oat bird-cherry aphid), Saissetia spp. (scales), Saissetia oleae (black scale), Schizaphis graminum (greenbug), Sitobion avenae (English grain aphid), Sogatella furcifera (white-backed planthopper), Therioaphis spp. (aphids), Toumeyella spp. (scales), Toxoptera spp. (aphids), Trialeurodes spp. (whiteflies), Trialeurodes vaporariorum (greenhouse whitefly), Trialeurodes abutiloneus (bandedwing whitefly), Unaspis spp. (scales), Unaspis yanonensis (arrowhead scale) and Zulia entreriana.

In yet another embodiment, the insect pests are of the order Lepidoptera, such as Achoea janata, Adoxophyes spp., Adoxophyes orana, Agrotis spp. (cutworms), Agrotis ipsilon (black cutworm), Alabama argillacea (cotton leafworm), Amorbia cuneana, Amyelosis transitella (navel orangeworm), Anacamptodes defectaria, Anarsia lineatella (peach twig borer), Anomis sabulifera (jute looper), Anticarsia gemmatalis (velvetbean caterpillar), Archips argyrospila (fruittree leafroller), Archips rosana (rose leaf roller), Argyrotaenia spp. (tortricid moths), Argyrotaenia citrana (orange tortrix), Autographa gamma, Bonagota cranaodes, Borbo cinnara (rice leaf folder), Bucculatrix thurberiella (cotton leafperforator), Caloptilia spp. (leaf miners), Capua reticulana, Carposina niponensis (peach fruit moth), Chilo spp., Chlumetia transversa (mango shoot borer), Choristoneura rosaceana (obliquebanded leafroller), Chrysodeixis spp., Cnaphalocerus medinalis (grass leafroller), Colias spp., Conpomorpha cramerella, Cossus (carpenter moth), Crambus spp. (Sod webworms), Cydia funebrana (plum fruit moth), Cydia molesta (oriental fruit moth), Cydia nignicana (pea moth), Cydia pomonella (codling moth), Darna diducta, Diaphania spp. (stem borers), Diatraea spp. (stalk borers), Diatraea saccharalis (sugarcane borer), Diatraea graniosella (southwester corn borer), Earias spp. (bollworms), Earias insulata (Egyptian bollworm), Earias vitella (rough northern bollworm), Ecdytopopha aurantianum, Elasmopalpus lignosellus (lesser cornstalk borer), Epiphysias postruttana (light brown apple moth), Ephestia spp. (flour moths), Ephestia cautella (almond moth), Ephestia elutella (tobbaco moth), Ephestia kuehniella (Mediterranean flour moth), Epimeces spp., Epinotia aporema, Erionota thrax (banana skipper), Eupoecilia ambiguella (grape berry moth), Euxoa auxiliaris (army cutworm), Feltia spp. (cutworms), Gortyna spp. (stemborers), Grapholita molesta (oriental fruit moth), Hedylepta indicata (bean leaf webber), Helicoverpa spp. (noctuid moths), Helicoverpa armigera (cotton bollworm), Helicoverpa zea (bollworm/corn earworm), Heliothis spp. (noctuid moths), Heliothis virescens (tobacco budworm), Hellula undalis (cabbage webworm), Indarbela spp. (root borers), Keiferia lycopersicella (tomato pinworm), Leucinodes orbonalis (eggplant fruit borer), Leucoptera malifoliella, Lithocollectis spp., Lobesia botrana (grape fruit moth), Loxagrotis spp. (noctuid moths), Loxagrotis albicosta (western bean cutworm), Lymantria dispar (gypsy moth), Lyonetia clerkella (apple leaf miner), Mahasena corbetti (oil palm bagworm), Malacosoma spp. (tent caterpillars), Mamestra brassicae (cabbage armyworm), Maruca testulalis (bean pod borer), Metisa plana (bagworm), Mythimna unipuncta (true armyworm), Neoleucinodes elegantalis (small tomato borer), Nymphula depunctalis (rice caseworm), Operophthera brumata (winter moth), Ostrinia nubilalis (European corn borer), Oxydia vesulia, Pandemis cerasana (common currant tortrix), Pandemis heparana (brown apple tortrix), Papilio demodocus, Pectinophora gossypiella (pink bollworm), Peridroma spp. (cutworms), Peridroma saucia (variegated cutworm), Perileucoptera coffeella (white coffee leafminer), Phthorimaea operculella (potato tuber moth), Phyllocnisitis citrella, Phyllonorycter spp. (leafminers), Pieris rapae (imported cabbageworm), Plathypena scabra, Plodia interpunctella (Indian meal moth), Plutella xylostella (diamondback moth), Polychrosis viteana (grape berry moth), Prays endocarpa, Prays oleae (olive moth), Pseudaletia spp. (noctuid moths), Pseudaletia unipunctata (armyworm), Pseudoplusia includens (soybean looper), Rachiplusia nu, Scirpophaga incertulas, Sesamia spp. (stemborers), Sesamia inferens (pink rice stem borer), Sesamia nonagrioides, Setora nitens, Sitotroga cerealella (Angoumois grain moth), Sparganothis pilleriana, Spodoptera spp. (armyworms), Spodoptera exigua (beet armyworm), Spodoptera fugiperda (fall armyworm), Spodoptera oridania (southern armyworm), Synanthedon spp. (root borers), Thecla basilides, Thermisia gemmatalis, Tineola bisselliella (webbing clothes moth), Trichoplusia ni (cabbage looper), Tuta absoluta, Yponomeuta spp., Zeuzera coffeae (red branch borer) and Zeuzera pyrina (leopard moth).

In yet another embodiment, the insect pests are of the order Orthoptera, such as Anabrus simplex (Mormon cricket), Gryllotalpidae (mole crickets), Locusta migratoria, Melanoplus spp. (grasshoppers), Microcentrum retinerve (angularwinged katydid), Pterophylla spp. (kaydids), chistocerca gregaria, Scudderia furcata (forktailed bush katydid) and Valanga nigricorni.

In yet another embodiment, the insect pests are of the order Thysanoptera, such as Frankliniella fusca (tobacco thrips), Frankliniella occidentalis (western flower thrips), Frankliniella shultzei Frankliniella williamsi (corn thrips), Heliothrips haemorrhaidalis (greenhouse thrips), Riphiphorothrips cruentatus, Scirtothrips spp., Scirtothrips citri (citrus thrips), Scirtothrips dorsalis (yellow tea thrips), Taeniothrips rhopalantennalis and Thrips spp.

In a specific embodiment, the insect pests are chewing pests.

In another specific embodiment, the insect pests are Helicoverpa spp.

In another specific embodiment, the insect pests are Spodoptera spp.

The effective application rates of the anthranilamide compound of formula (I) and tau-fluvalinate cannot generally be defined, as it varies depending upon various conditions such as the type of the formulation, weather conditions, the type of crop and the type of pests.

The application rates of the combination may vary, depending on the desired effect. In an embodiment, depending on the desired effect, the application rates of the combination according to the invention are from 1 g/ha to 10000 g/ha, particularly from 50 to 5000 g/ha, more particularly from 100 to 2000 g/ha. In another embodiment, the application rate of the combination according to the invention are from 500 g/ha to 1000 g/ha. In another embodiment, the application rate of the combination according to the invention are from 1 g/ha to 500 g/ha.

Correspondingly, the application rates of the anthranilamide compound of formula (I) are generally from 1 to 1000 g/ha. In some embodiments, the application rates of the anthranilamide compound of formula (I) are generally from 1 to 500 g/ha, particularly from 1-250 g/ha.

Correspondingly, the application rates for the tau-fluvalinate are generally from 1 to 4000 g/ha. In some embodiments, the application rates for the insecticidal compound are generally from 1 to 2500 g/ha. In some embodiments, the application rates for the insecticidal compound are generally from 1 to 1000 g/ha, particularly from 1-500 g/ha, more particularly from 1-250 g/ha.

In some embodiments, the application rates of the anthranilamide compound of formula (I) are 1-250 g/l, and the application rates of tau-fluvalinate are 1-1000 g/l.

In another embodiment, the anthranilamide compound of formula (I), and tau-fluvalinate can be applied simultaneously, that is jointly or separately, or in succession, the sequence, in the case of separate application, generally not having any effect on the result of the control measures.

That is, each of the anthranilamide compound of formula (I), and tau-fluvalinate may be applied jointly or in succession. In one example, the anthranilamide compound of formula (I), and tau-fluvalinate are prepared separately, and the individual formulations are applied as is, or diluted to predetermined concentrations. In a further example, the anthranilamide compound of formula (I), and tau-fluvalinate are prepared separately, and the formulations are mixed when diluted to a predetermined concentration. In another example, the anthranilamide compound of formula (I), and tau-fluvalinate are formulated together, and the formulation is applied as it is, or the formulation is diluted to a predetermined concentration.

In one embodiment, the composition comprising the anthranilamide compound of formula (I) and tau-fluvalinate are for the control of chewing pests.

The chewing pests are as described herein. In a specific embodiment, the chewing pests are Helicoverpa spp and/or Spodoptera spp.

In yet another embodiment, the synergistic composition may be applied in various mixtures or combinations of the anthranilamide compound of formula (I) and tau-fluvalinate. For example in a single “ready-for-use” form, or in a combined spray mixture composed from separate formulations of the single active ingredients, such as a “tank-mix” form.

In yet another embodiment, the composition is applied in the form of a ready-for-use formulation comprising the anthranilamide compound of formula (I) (e.g. chlorantraniliprole), and tau-fluvalinate. This formulation can be obtained by combining the active ingredients in an effective amount with an agriculturally acceptable carrier, a surfactant or other application-promoting adjuvant customarily employed in formulation technology.

The present composition may be employed or prepared in any conventional form, for example, as wettable powders (WP), emulsion concentrates (EC), microemulsion concentrates (MEC), water-soluble powders (SP), water-soluble concentrates (SL), suspoemulsion (SE), oil dispersions (OD), concentrated emulsions (BW) such as oil-in-water and water-in-oil emulsions, sprayable solutions or emulsions, capsule suspensions (CS), suspension concentrates (SC), suspension concentrates, dusts (DP), oil-miscible solutions (OL), seed-dressing products, granules (GR) in the form of microgranules, spray granules, coated granules and absorption granules, granules for soil application or broadcasting, water-soluble granules (SG), water-dispersible granules (WDG), ULV formulations, microcapsules or waxes. These individual formulation types are known in the art.

According to an embodiment, the composition comprises at least one additional component selected from the group of surfactants, solid diluents and liquid diluents.

Such compositions can be formulated using agriculturally acceptable carriers, surfactants or other application-promoting adjuvants customarily employed in formulation technology and formulation techniques that are known in the art.

Examples of suitable liquid carriers potentially useful in the present compositions include but are not limited to water; aromatic hydrocarbons such as alkylbenzenes and alkylnaphthalenes; alcohols such as cyclohexanol, and decanol; ethylene glycol; polypropylene glycol; dipropropylene glycol; N,N-dimethylformamide; dimethylsulfoxide; dimethylacetamide; N-alkylpyrrolidones such as N-methyl-2-pyrrolidone; paraffins; various oils such as olive, castor, linseed, tung, sesame, corn, peanut, cotton-seed, soybean, rape-seed, or coconut oil; fatty acid esters; ketones such as cyclohexanone, 2-heptanone, isophorone, and 4-hydroxy-4-methyl-2-pentanone; and the like.

Examples of suitable solid carriers potentially useful in the present compositions include but are not limited to mineral earths such as silica gels, silicates, talc, kaolin, sericite, attaclay, limestone, bentonite, lime, chalk, bole, mirabilite, loess, clay, dolomite, zeolite, diatomaceous earth, calcium carbonate, calcium sulfate, magnesium sulfate, magnesium oxide, sodium carbonate and bicarbonate, and sodium sulfate; ground synthetic materials; fertilizers such as ammonium sulfate, ammonium phosphate, ammonium nitrate, ureas, and products of vegetable origin, such as cereal meal, tree bark meal, wood meal, and nutshell meal; cellulose powders; and other solid carriers.

Examples of suitable surfactants include, but are not limited to, non-ionic, anionic, cationic and ampholytic types such as alkoxylated fatty alcohols, ethoxylated polysorbate (e.g. tween 20), ethoxylated castor oil, lignin sulfonates, fatty acid sulfonates (e.g. lauryl sulfonate), phosphate esters such as phosphate esters of alcohol alkoxylates, phosphate esters of alkylphenol alkoxylates and phosphate esters of styrylphenol ethoxylates, condensates of sulfonated naphthalene and naphthalene derivatives with formaldehyde, condensates of naphthalene or of naphthalenesulfonic acid with phenol and formaldehyde, alkylarylsulfonates, ethoxylated alkylphenols and aryl phenols, polyalkylene glycols, sorbitol esters, alkali metal, sodium salts of lignosulphonates, tristyrylphenol ethoxylate phosphate esters, aliphatic alcohol ethoxylates, alkylphenol ethoxylates, ethylene oxide/propylene oxide block copolymers, graft copolymers and polyvinyl alcohol-vinyl acetate copolymers. Other surfactants known in the art may be used as desired.

Other ingredients, such as wetting agents, anti-foaming, adhesives, neutralizers, thickeners, binders, sequestrates, fertilizers, biocides, stabilizers, buffers or anti-freeze agents, may also be added to the present compositions in order to increase the stability, density, and viscosity of the described compositions.

Aqueous use forms can be prepared from emulsion concentrates, suspensions, pastes, wettable powders or water-dispersible granules by adding water. To prepare emulsions, pastes or oil dispersions, the components of the compositions either as such or dissolved in an oil or solvent, can be homogenized in water by means of a wetting agent, tackifier, dispersant or emulsifier. Alternatively, it is also possible to prepare concentrates comprising active ingredient, wetting agent, tackifier, dispersant or emulsifier and, if desired, a solvent or oil, which are suitable for dilution with water.

In one embodiment, the amount of the combination of active ingredients in the composition is about 0.1-99 wt. %, about 0.1-95 wt. %, or about 0.1-90 wt. %, based on the total weight of the composition. In another embodiment, the amount of the combination of active ingredients in the composition is about 1-70 wt. %, based on the total weight of the composition. In yet another embodiment, the amount of the combination of active ingredients in the composition is about 1-50 wt. %, based on the total weight of the composition. In yet another embodiment, the amount of the combination of active ingredients in the composition is about 1-40 wt. %, based on the total weight of the composition. In yet another embodiment, the amount of the combination of active ingredients in the composition is about 1-30 wt. %, based on the total weight of the composition. In yet another embodiment, the amount of the combination of active ingredients in the composition is about 1-20 wt. %, based on the total weight of the composition. In yet another embodiment, the amount of the combination of active ingredients in the composition is about 1-10 wt. %, based on the total weight of the composition. The remaining components in the formulation are for example the carrier and additives.

In one embodiment, the amount of the combination of active ingredients in the composition is from about 0.1%, 0.5%, 1%, 1.5%, 2%, 2.5%, 3%, 3.5%, 4%, 4.5%, 5% to about 90%, 93%, 95%, 98%, 99% based on the total weight of the composition.

The present composition may include additional crop protection agents, for example insecticides, herbicides, fungicides, bactericides, nematicides, molluscicides, growth regulators, biological agents, fertilizers, or mixtures thereof. However, for the avoidance of doubt it is understood that such additional crop protection agents are unnecessary to achieve the desired control of pests as achieved by the present combinations.

In another embodiment, the present invention provides a kit comprising a synergistic pesticidal composition as described herein, or components thereof. Such kits may comprise, in addition to the aforementioned active components, one or more additional active and/or inactive ingredients, either within the provided pesticidal composition or separately.

As noted above, the compositions, kits and methods described herein exhibit a synergistic effect. A synergistic effect exists wherever the action of a combination of active components is greater than the sum of the action of each of the components alone. Therefore, a synergistically effective amount (or an effective amount of a synergistic composition or combination) is an amount that exhibits greater pesticidal activity than the sum of the activities of the individual components.

### Method of Use

It was found that application of tau-fluvalinate in the presence of anthranilamide compound of formula (I) has an increased biological efficacy toward chewing pest. The commercially available tau-fluvalinate formulation i.e. Mavrik®, has lower efficacy against chewing pests. More specifically, for obtaining 70% level of control, a high rate of tau fluvalinate is required. The combination as disclosed in this application is effective against chewing pest and controls a broader spectrum of pests.

The present invention also relates to a method for control of chewing pests by contacting the insect or their food supply, habitat, breeding grounds or their locus with a synergistically effective amount of a combination of (i) an anthranilamide compound of formula (I); and (ii) tau fluvalinate.

In some embodiments, the combination is synergistic.

In some embodiments, the chewing pest is of the order Coleoptera, Lepidoptera and/or Orthoptera.

In some embodiments, the chewing pests in connection with plant are of the order Diptera, such as Agromyza frontella (alfalfa blotch leafminer), Agromyza spp. (leaf miner flies), Anastrepha spp. (fruit flies), Anastrepha suspensa (Caribbean fruit fly), Bactrocera dorsalis (oriental fruit fly), Ceratitis spp. (fruit flies), Ceratitis capitata (Mediterranea fruit fly), Dasineura brassicae (cabbage gall midge), Drosophila spp. (vinegarflies), Hylemyia spp. (root maggots), Liriomyza spp. (leafminerflies), Liriomyza brassica (serpentine leafminer), Sitodiplosis mosellana (orange wheat blossom midge).

In some embodiments, the chewing pests are of the order Hemiptera, such as Acrosternum hilare (green stink bug), Calocoris norvegicus (potato mirid), Eurygaster maura (cereal bug), Euschistus heros, Euschistus servus (brown stink bug), Helopeltis antonii, Helopeltis theivora (tea blight plantbug), Lagynotomus spp. (stink bugs), Leptocorisa oratorius, Leptocorisa varicornis, Lygus spp. (plant bugs), Nezara viridula (southern green stink bug), Phytocoris spp. (plant bugs), Phytocoris californicus, Phytocoris relativus, Piezodorus guildingi, Poecilocapsus lineatus (fourlined plant bug).

In some embodiments, the chewing pest is of the order Lepidoptera.

In one embodiment, the chewing pest is Helicoverpa spp. and/or Spodoptera spp.

The present invention provides a method for enhancing root systems and/or enhancing crop plants development and/or enhancing crop plants vigor and/or improving plant potential yield comprising applying an effective amount of the any one of the combinations or compositions disclosed herein to one or more plants, the locus thereof or propagation material thereof.

The present invention provides a method for enhancing plant development comprising applying an effective amount of the any one of the combinations or the compositions disclosed herein to one or more plants, the locus thereof or propagation material thereof so as to thereby enhance plant development.

The present invention provides a method for enhancing root system comprising applying an effective amount of the any one of the combinations or the compositions disclosed herein to one or more plants, the locus thereof or propagation material thereof so as to thereby enhance the root system.

The present invention provides a method for enhancing plant vigor comprising applying an effective amount of the any one of the combinations or the compositions disclosed herein to one or more plants, the locus thereof or propagation material thereof so as to thereby enhance plant vigor.

The present invention provides a method for improving plant potential yield comprising applying an effective amount of the any one of the combinations or the compositions disclosed herein to one or more plants, the locus thereof or propagation material thereof so as to thereby improve plant potential yield.

The present invention provides a method for regulating plant growth comprising applying an effective amount of the any one of the combinations or the compositions disclosed herein to one or more plants, the locus thereof or propagation material thereof so as to thereby regulate plant growth.

The present invention provides a method for control of insects by contacting the insect or their food supply, habitat, breeding grounds or their locus with an effective amount of the any one of the combinations or the compositions disclosed herein so as to thereby control insects.

The present invention provides a method of protecting plants from attack or infestation by insects comprising contacting the plant, or the soil or water in which the plant is growing, with an effective amount of the any one of the combinations or the compositions disclosed herein so as to thereby protecting plants from attack or infestation by insects.

The present invention provides a method for increasing resistance to the compound of Formula (I) comprising contacting the plant, or the soil or water in which the plant is growing, with an effective amount of the combination or composition of the present invention so as to thereby increasing resistance to the compound of Formula (I).

The present invention also provides a method of increasing plant resistance to the compound of Formula (I) wherein the method comprises applying an effective amount of at least one insecticidal compound to the plant so as to thereby increase the resistance of the plant to the compound of Formula (I) compared to the resistance of same plant to which the insecticidal compound was not applied.

The present invention also provides a method for enhancing plant growth comprising applying an effective amount of any one of the combinations and/or compositions disclosed herein to one or more plants, the locus thereof or propagation material thereof.

The present invention provides a method of enhancing knock-down activity and/or prolonged control comprising contacting the plant, or the soil or water in which the plant is growing, with an effective amount of the any one of the combinations or the compositions disclosed herein so as to thereby enhance knock-down activity and/or prolonged control.

In some embodiments, the combinations and formulations of the present invention are applied as a knock-down treatment.

In some embodiments, the combinations and formulations of the present invention are applied to provide prolonged insecticidal control.

In some embodiments, the rate of application of the anthranilamide compound of formula (I) is 1-250 g/ha. In some embodiments, the rate of application of the anthranilamide compound of formula (I) is 30 g/ha.

In some embodiments, the rate of application of tau-fluvalinate is 1-1000 g/ha. In some embodiments, the rate of application of tau-fluvalinate is between 40-250 g/ha.

In some embodiments, when the pest is Helicoverpa armigera (Heliotis), Tuta absoluta, Liriomyza trifolio or combination thereof, the rate of application of tau-fluvalinate is between 100-150 g/ha

In some embodiments, where the pest is Leucinodes orbonalis, Cnaphalocrocis mainsails or combination thereof, the rate of application of tau-fluvalinate is between 40-50 g/ha

The following examples illustrate the practice of the present invention in some of its embodiments, but should not be construed as limiting the scope of the invention. Other embodiments will be apparent to one skilled in the art from consideration of the specification and examples. It is intended that the specification, including the examples, is considered exemplary only without limiting the scope and spirit of the invention.

In some embodiments, the combination or synergistic combination comprises one or more additional active ingredient(s). In some embodiments, the combination or synergistic combination comprises one or more additional non-active ingredient(s).

### EXAMPLES

### Example 1

The aims of the experiments to evaluate the joint activity of chlorantraniliprole with tau-fluvalinate on larvae of S. littoralis and H. armigera.

### Materials and Methods

### Insects

The laboratory susceptible strain of S. littoralis is collected in 2000 from a cotton field in Bet She'an area (south-eastern part of Israel) and is reared on castor bean (Ricinus communis) leaves under standard rearing conditions of 27° C., 55% RH and 14 h photoperiod. Field strain of H. armigera was collected in June 2020 from cotton fields near Rehovot area and was reared on premixed diet (Ward's Stonefly Heliothis Diet, USA) under standard rearing conditions of 27° C., 55% RH and 14 h photoperiod.

### Insecticides

1. Chlorantraniliprole (Rynaxypyr®, Coragen®, 20 SC) a diamide insecticide (“C”).
2. Tau-fluvalinate (Mavrik®, 240 g/L EC) a synthetic pyrethroid (“M”).

### Bioassays

Spodoptera littoralis larvae

Assays with S. littoralis larvae were done as described by Ishaaya et al. (1996, 2003). Castor bean leaves were dipped in various concentrations of the test compounds (and water as control), and were air dried for 2 h under controlled room conditions. The treated leaves were transferred into foam plastic (“Kalkar”) cups containing a layer of sawdust to avoid humidity. The treated leaves were offered to early 3rd-instar (12±1 mg) for 4-day feeding of the laboratory susceptible strain and for additional 4 days on untreated leaves. Larval mortality was determined and recorded on day 4 and 8 or as indicated, and larval weight gain (LWG) was determined on day 4 and 8 or as indicated.

Helicoverpa armigera larvae

Tender leaves of cotton were dipped in aqueous concentrations of a formulation or in water as control. After 15 seconds of dipping, the cotton leaves were then allowed to air dry for 2 h. Afterwards, Heliothis larvae (third instars, 8-10 mm), reared in a controlled growth room (27±2° C. and 50% RH with a photoperiod of 14:10 h light:dark) were put inside Petri dishes on treated cotton leaves; in addition, filter papers were also added to the dishes (to avoid too much moisture). The experiments were done on 5-10 larvae for each concentration and were repeated three times, on separate days.

Mortality of the larvae in comparison with the control was determined, two and five-six days after exposure to the formulations.

To obtain a concentration-mortality line, at least three concentrations were used for most of the bioassays. LC values were estimated by probit analysis (POLO, 1987). Control mortality was corrected using Abbott's (1925) formula.

Mixture of Chlorantraniliprole with Tau-Fluvalinate

Firstly, all the compounds were assessed alone against the larvae, and then, binary mixtures of chlorantraniliprole with tau-fluvalinate were evaluated in different ratios. Lethal concentrations of the compounds for Spodoptera littoralis and Helicoverpa armigera are listed in Table 1 below.

TABLE 1

| | | | | Lethal |
|---|---|---|---|---|
| | | | Lethal | concentrations |
| | | | concentrations | for Helicoverpa |
| | | Load and | for Spodoptera | armigera |
| Al | Product | formulation | littoralis | (Heliothis) |
| Chlorantraniliprole | Coragen ® | 200 g/L SC | LD50 = 0.1 ppm | LD50 ≥ 0.1 ppm |
| | | | LD90 = 1 ppm | LD90 ≥ 1 ppm |
| Tau-fluvalinate | Mavrik ® | 240 g/L EC | LD50 ≥ 100 ppm | LD50 ≥ 100 ppm |
| | | | LD90 ≥ 500 ppm | LD90 ≥ 500 ppm |

1. Effect of Each Compound on S. littoralis

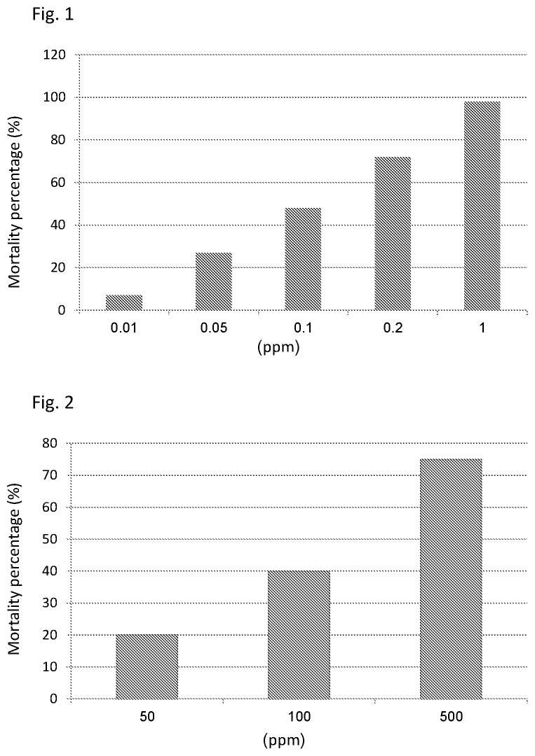

The effect of each one of the compounds Chlorantraniliprole (Coragen®) and Tau-fluvalinate (Mavrik®) on the mortality rate of S. littoralis is shown in FIG. 1 and in FIG. 2, respectively.

TABLE 2
Effect of combination of Coragen (C) and
Mavrik (M) on S. littoralis larvae

| | S. littoralis | Calculated |
|---|---|---|
| Concentration, ppm | mortality, % | (Colby) |
| tau fluvalinate 50 | 20 | |
| tau fluvalinate 100 | 40 | |
| Chlorantraniliprole 0.05 | 27 | |
| Chlorantraniliprole 0.1 | 48 | |
| M 50 + C 0.1 | 70 | 58.4 |
| M 100 + C 0.1 | 80 | 68.8 |

### 2. Effect of Each Compound on H. Airmigera

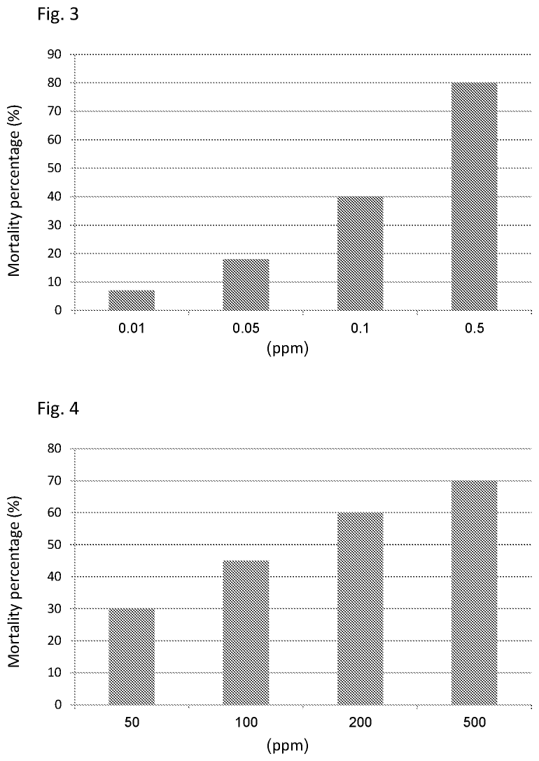

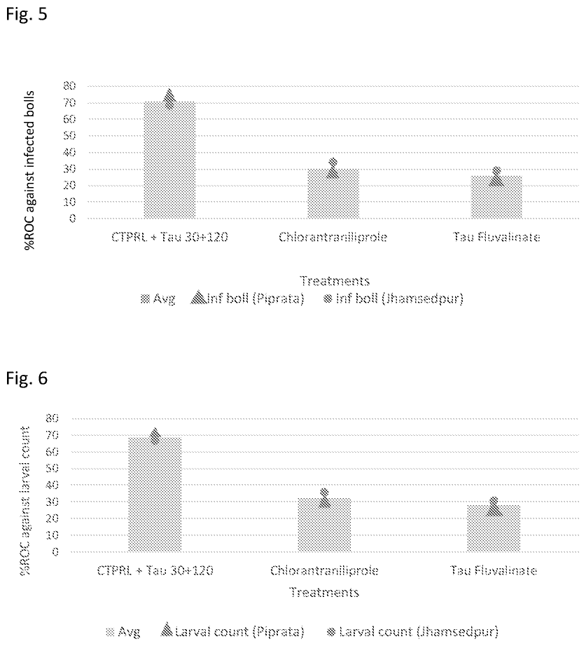

The effect of each one of the compounds Coragen® and Mavrik® on the mortality rate of H. armigera is shown in FIG. 3 and in FIG. 4, respectively.

TABLE 3
Effect of mixture of Coragen (C) and
Mavrik (M) on H. armigera larvae

| | H. armigera | Calculated |
|---|---|---|
| Concentration, ppm | mortality, % | (Colby) |
| tau fluvalinate 50 | 30 | |
| tau fluvalinate 100 | 45 | |
| Chlorantraniliprole 0.05 | 18 | |
| Chlorantraniliprole 0.1 | 40 | |
| M 50 + C0.05 | 47 | 42.6 |
| M 100 + C0.05 | 60 | 54.9 |
| M 50 + C 0.1 | 85 | 58 |
| M 100 + C 0.1 | 90 | 67 |

### Example 2

The aim is to evaluate the joint activity of chlorantraniliprole with tau-fluvalinate against Pink Bollworm.

TABLE 4
Trials:

| Trial Details | MP1 | MP2 |
|---|---|---|
| Location | Piprata, Khargone-(MP) | Jamshedpur, Khargone (MP) |
| Crop | Cotton/Rashi 659 | Cotton/Raja |
| Variety | 25 m² | 25 m² |
| Date of Applications (A) | 92DAS | 75DAS |
| Date of Applications (B) | 14 days after application | 14 days after application (A) |
| | (A) | |

DAS, days after sowing.

What is claimed is:

1) A insecticidal combination comprising: (i) an anthranilamide compound of formula (I) 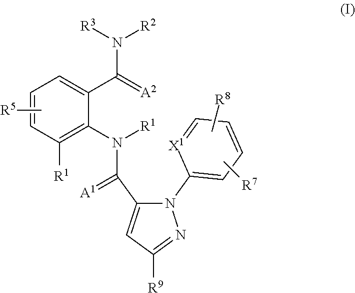
in which
A¹ and A² independently of one another represent oxygen or sulfur,
X¹ represents N or CR¹⁰,
R¹ represents hydrogen or represents C₁-C₆-alkyl, C₂-C₆-alkenyl, C₂-C₆-alkynyl or C₃-C₆-cycloalkyl, each of which is optionally mono- or polysubstituted, where the substituents independently of one another may be selected from the group consisting of R⁶, halogen, cyano, nitro, hydroxyl, C₁-C₄-alkoxy, C₁-C₄-alkylthio, C₁-C₄-alkylsulfinyl, C₁-C₄-alkylsulfonyl, C₂-C₄-alkoxycarbonyl, C₁-C₄-alkylamino, C₂-C₈-dialkylamino, C₃-C₆-cycloalkylamino, (C₁-C₄-alkyl)-C₃-C₆-cycloalkylamino and R¹¹,
R² represents hydrogen, C₁-C₆-alkyl, C₂-C₆-alkenyl, C₂-C₆-alkynyl, C₃-C₆-cycloalkyl, C₁-C₄-alkoxy, C₁-C₄-alkylamino, C₂-C₈-dialkylamino, C₃-C₆-cycloalkylamino, C₂-C₆-alkoxycarbonyl or C₂-C₆-alkylcarbonyl,
R³ represents hydrogen, R¹¹ or represents C₁-C₆-alkyl, C₂-C₆-alkenyl, C₂-C₆-alkynyl, C₃-C₆-cycloalkyl, each of which is optionally mono- or polysubstituted, where the substituents independently of one another may be selected from the group consisting of R⁶, halogen, cyano, nitro, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₂-C₆-alkoxycarbonyl, C₂-C₆-alkylcarbonyl, C₃-C₆-trialkylsilyl, R¹¹, phenyl, phenoxy and a 5- or 6-membered heteroaromatic ring, where each phenyl, phenoxy and 5- or 6-membered heteroaromatic ring may optionally be substituted and where the substituents independently of one another may be selected from one to three radicals W or one or more radicals R¹², or
R² and R³ may be attached to one another and form the ring M,
TABLE 5
Treatments:

| Treatment | Dose g a.i/ha | Dose g or ml/ha |
|---|---|---|
| Untreated Control | NA | NA |
| CTPRL + Tau fluvalinate (Tank mix) | 30 + 120 | 150 + 500 |
| Chlorantraniliprole 20% SC | 30 | 150 |
| Tau Fluvalinate 24% EW | 120 | 500 |

TABLE 6
Results:

| | Inf boll | Inf boll | |
|---|---|---|---|
| | (Piprata) | (Jhamsedpur) | Avg |
| CTPRL + Tau 30 + 120 | 72.48 | 68.42 | 70.77 |
| Chlorantraniliprole | 27.52 | 34.21 | 30.26 |
| Tau Fluvalinate | 23.85 | 28.95 | 25.94 |

TABLE 7
Results

| | Larval | | |
|---|---|---|---|
| | count | Larval count | |
| | (Piprata) | (Jhamsedpur) | Avg |
| CTPRL + Tau 30 + 120 | 70.09 | 66.67 | 68.61 |
| Chlorantraniliprole | 29.91 | 35.9 | 32.43 |
| Tau Fluvalinate | 26.17 | 30.77 | 28.1 |

The results shown in Table 7 above are graphically presented in FIG. 6.
R⁴ represents hydrogen, C₁-C₆-alkyl, C₂-C₆-alkenyl, C₂-C₆-alkynyl, C₃-C₆-cycloalkyl, C₁-C₆-haloalkyl, C₂-C₆-haloalkenyl, C₂-C₆-haloalkynyl, C₃-C₆-halocycloalkyl, halogen, cyano, nitro, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl, C₁-C₄-alkylamino, C₂-C₈-dialkylamino, C₃-C₆-cycloalkylamino, C₃-C₆-trialkylsilyl or represents phenyl, benzyl or phenoxy, each of which is optionally mono- or polysubstituted, where the substituents independently of one another may be selected from the group consisting of C₁-C₄-alkyl, C₂-C₄-alkenyl, C₂-C₄-alkynyl, C₃-C₆-cycloalkyl, C₁-C₄-haloalkyl, C₂-C₄-haloalkenyl, C₂-C₄-haloalkynyl, C₃-C₆-halocycloalkyl, halogen, cyano, nitro, C₁-C₄-alkoxy, C₁-C₄-haloalkoxy, C₁-C₄-alkylthio, C₁-C₄-alkylsulfinyl, C₁-C₄-alkylsulfonyl, C₁-C₄-alkylamino, C₂-C₈-dialkylamino, C₃-C₆-cycloalkylamino, C₃-C₆-(alkyl)cycloalkylamino, C₂-C₄-alkylcarbonyl, C₂-C₆-alkoxycarbonyl, C₂-C₆-alkylaminocarbonyl, C₃-C₈-dialkylaminocarbonyl and C₃-C₆-trialkylsilyl,
R⁵ and R⁸ in each case independently of one another represent hydrogen, halogen or represent in each case optionally substituted C₁-C₄-alkyl, C₁-C₄-haloalkyl, R¹², G, J, —OJ, —OG, —S(O)ₚ-J, —S(O)ₚG, —S(O)ₚ-phenyl, where the substituents independently of one another may be selected from one to three radicals W or from the group consisting of R¹², C₁-C₁₀-alkyl, C₂-C₆-alkenyl, C₂-C₆-alkynyl, C₁-C₄-alkoxy and C₁-C₄-alkylthio, where each substituent may be substituted by one or more substituents independently of one another selected from the group consisting of G, J, R⁶, halogen, cyano, nitro, amino, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl, C₁-C₄-alkylamino, C₂-C₈-dialkylamino, C₃-C₆-trialkylsilyl, phenyl and phenoxy, where each phenyl or phenoxy ring may optionally be substituted and where the substituents independently of one another may be selected from one to three radicals W or one or more radicals R¹²,
G in each case independently of one another represents a 5- or 6-membered non-aromatic carbocyclic or heterocyclic ring which may optionally contain one or two ring members from the group consisting of C(═O), SO and S(═O)₂ and which may optionally be substituted by one to four substituents independently of one another selected from the group consisting of C₁-C₂-alkyl, halogen, cyano, nitro and C₁-C₂-alkoxy, or independently of one another represents C₂-C₆-alkenyl, C₂-C₆-alkynyl, C₃-C₇-cycloalkyl, (cyano)-C₃-C₇-cycloalkyl, (C₁-C₄-alkyl)-C₃-C₆-cycloalkyl, (C₃-C₆-cycloalkyl)-C₁-C₄-alkyl, where each cycloalkyl, (alkyl)cycloalkyl and (cycloalkyl)alkyl may optionally be substituted by one or more halogen atoms,
J in each case independently of one another represents an optionally substituted 5- or 6-membered heteroaromatic ring, where the substituents independently of one another may be selected from one to three radicals W or one or more radicals R¹²,
R⁶ independently of one another represents —C(=E¹)R¹⁹, -L(=E¹)R¹⁹, —C(=E¹)LR¹⁹, -LC(=E¹)LR¹⁹, —OP(=Q)(OR¹⁹)₂, —SO₂LR¹⁸ or -LSO₂LR¹⁹, where each E¹ independently of one another represents O, S, N—R¹⁵, N—OR¹⁵, N—N(R¹⁵)₂, N—S═O, N—CN or N—NO₂,
R⁷ represents hydrogen, C₁-C₄-alkyl, C₁-C₄-haloalkyl, halogen, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl,
R⁹ represents C₁-C₄-haloalkyl, C₁-C₄-haloalkoxy, C₁-C₄-haloalkylsulfinyl or halogen,
R¹⁰ represents hydrogen, C₁-C₄-alkyl, C₁-C₄-haloalkyl, halogen, cyano or C₁-C₄-haloalkoxy,
R¹¹ in each case independently of one another represents in each case optionally mono- to trisubstituted C₁-C₆-alkylthio, C₁-C₆-alkylsulfenyl, C₁-C₆-haloalkylthio, C₁-C₆-haloalkylsulfenyl, phenylthio or phenylsulfenyl, where the substituents independently of one another may be selected from the list W, —S(O)ₙN(R¹⁶)₂, —C(═O)R¹³, -L(C═O)R¹⁴, —S(C═O)LR¹⁴, —C(═O)LR¹³, —S(O)ₙNR¹³C(═O)R¹³, —S(O)ₙNR¹³C(═O)LR¹⁴ or —S(O)ₙNR¹³S(O)₂LR¹⁴,
L in each case independently of one another represents O, NR¹⁸ or S,
R¹² in each case independently of one another represents —B(OR¹⁷)₂, amino, SH, thiocyanato, C₃-C₈-trialkylsilyloxy, C₁-C₄-alkyl disulfides, —SF₅, —C(=E¹)R¹⁹, -LC(=E¹)R¹⁹, —C(=E¹)LR¹⁹, -LC(=E¹)LR¹⁹, —OP(=Q)(OR¹⁹)₂, —SO₂LR¹⁹ or -LSO₂LR¹⁹,
Q represents O or S,
R¹³ in each case independently of one another represents hydrogen or represents in each case optionally mono- or polysubstituted C₁-C₆-alkyl, C₂-C₆-alkenyl, C₂-C₆-alkynyl or C₃-C₆-cycloalkyl, where the substituents independently of one another may be selected from the group consisting of R⁶, halogen, cyano, nitro, hydroxyl, C₁-C₄-alkoxy, C₁-C₄-alkylsulfinyl, C₁-C₄-alkylsulfonyl, C₁-C₄-alkylamino, C₂-C₈-dialkylamino, C₃-C₆-cycloalkylamino or (C₁-C₄-alkyl)-C₃-C₆-cycloalkylamino,
R¹⁴ in each case independently of one another represents in each case optionally mono- or polysubstituted C₂-C₂₀-alkenyl, C₂-C₂₀-alkynyl or C₃-C₆-cycloalkyl, where the substituents independently of one another may be selected from the group consisting of R⁶, halogen, cyano, nitro, hydroxyl, C₁-C₄-alkoxy, C₁-C₄-alkylsulfinyl, C₁-C₄-alkylsulfonyl, C₁-C₄-alkylamino, C₂-C₈-dialkylamino, C₃-C₆-cycloalkylamino and (C₁-C₄-alkyl)-C₃-C₆-cycloalkylamino or represent optionally substituted phenyl, where the substituents independently of one another may be selected from one to three radicals W or one or more radicals R¹²,
R¹⁵ in each case independently of one another represents hydrogen or represents in each case optionally mono- or polysubstituted C₁-C₆-haloalkyl or C₁-C₆-alkyl, where the substituents independently of one another may be selected from the group consisting of cyano, nitro, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl, C₁-C₄-alkylamino, C₂-C₈-dialkylamino, C₂-C₆-alkoxycarbonyl, C₂-C₆-alkylcarbonyl, C₃-C₆-trialkylsilyl and optionally substituted phenyl, where the substituents independently of one another may be selected from one to three radicals W or one or more radicals R¹², or N(R¹⁵)₂ represents a cycle which forms the ring M,
R¹⁶ represents C₁-C₁₂-alkyl or C₁-C₁₂-haloalkyl, or N(R¹⁶)₂ represents a cycle which forms the ring M,
R¹⁷ in each case independently of one another represents hydrogen or C₁-C₄-alkyl, or B(OR¹⁷)₂ represents a ring in which the two oxygen atoms are attached via a chain having two to three carbon atoms which are optionally substituted by one or two substituents independently of one another selected from the group consisting of methyl and C₂-C₆-alkoxycarbonyl,
R¹⁸ in each case independently of one another represents hydrogen, C₁-C₆-alkyl or C₁-C₆-haloalkyl, or N(R¹³)(R¹⁸) represents a cycle which forms the ring M,
R¹⁹ in each case independently of one another represents hydrogen or represents in each case mono- or polysubstituted C₁-C₆-alkyl, where the substituents independently of one another may be selected from the group consisting of cyano, nitro, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl, C₁-C₄-alkylamino, C₂-C₈-dialkylamino, CO₂H, C₂-C₆-alkoxycarbonyl, C₂-C₆-alkylcarbonyl, C₃-C₆-trialkylsilyl and optionally substituted phenyl, where the substituents independently of one another may be selected from one to three radicals W, C₁-C₆-haloalkyl, C₃-C₆-cycloalkyl or phenyl or pyridyl, each of which is optionally mono- to trisubstituted by W,
M in each case represents an optionally mono- to tetrasubstituted ring which, in addition to the nitrogen atom attached to the substituent pair R¹³ and R¹⁸, (R¹⁵)₂ or (R¹⁶)₂, contains two to six carbon atoms and optionally additionally a further nitrogen, sulfur or oxygen atom, where the substituents independently of one another may be selected from the group consisting of C₁-C₂-alkyl, halogen, cyano, nitro and C₁-C₂-alkoxy,
W in each case independently of one another represents C₁-C₄-alkyl, C₂-C₄-alkenyl, C₂-C₄-alkynyl, C₃-C₆-cycloalkyl, C₁-C₄-haloalkyl, C₂-C₄-haloalkenyl, C₂-C₄-haloalkynyl, C₃-C₆-halocycloalkyl, halogen, cyano, nitro, C₁-C₄-alkoxy, C₁-C₄-haloalkoxy, C₁-C₄-alkylthio, C₁-C₄-alkylsulfonyl, C₁-C₄-alkylamino, C₂-C₈-dialkylamino, C₃-C₆-cycloalkylamino, (C₁-C₄-alkyl)-C₃-C₆-cycloalkylamino, C₂-C₄-alkylcarbonyl, C₂-C₆-alkoxycarbonyl, CO₂H, C₂-C₆-alkylaminocarbonyl, C₃-C₈-dialkylaminocarbonyl or C₃-C₆-trialkylsilyl,
n in each case independently of one another represents 0 or 1,
p in each case independently of one another represents 0, 1 or 2,
where, if (a) R⁵ represents hydrogen, C₁-C₆-alkyl, C₁-C₆-haloalkyl, C₂-C₆-haloalkenyl, C₂-C₆-haloalkynyl, C₁-C₄-haloalkoxy, C₁-C₄-haloalkylthio or halogen and (b) R⁸ represents hydrogen, C₁-C₆-alkyl, C₁-C₆-haloalkyl, C₂-C₆-haloalkenyl, C₂-C₆-haloalkynyl, C₁-C₄-haloalkoxy, C₁-C₄-haloalkylthio, halogen, C₂-C₄-alkylcarbonyl, C₂-C₆-alkoxycarbonyl, C₂-C₆-alkylaminocarbonyl or C₃-C₈ dialkylaminocarbonyl, (c) at least one substituent selected from the group consisting of R⁶, R¹¹ and R¹² if present and (d) if R¹² is not present, at least one of the radicals R⁶ and R¹¹ is different from C₂-C₆-alkylcarbonyl, C₂-C₆-alkoxycarbonyl, C₂-C₆-alkylaminocarbonyl and C₃-C₈-dialkylaminocarbonyl, and where the compound of the general formula (I) may also be an N-oxide or salt; and (ii) tau fluvalinate for controlling chewing pest.

2) The insecticidal combination of claim 1, wherein the anthranilamide compound is selected from the group comprising, chlorantraniliprole, cyantraniliprole, tetraniliprole, tetrachlorantraniliprole, bromantraniliprole, and cyclaniliprole.

3) The insecticidal combination of claim 1 or 2, wherein the anthranilamide compound is chlorantraniliprole.

4) The insecticidal combination of claim 1 or 2, wherein the anthranilamide compound is cyantraniliprole.

5) The insecticidal combination of claim 1 or 2, wherein the anthranilamide compound is cyclaniliprole.

6) The insecticidal combination of claim 1 or 2, wherein the anthranilamide compound is tetraniliprole.

7) The insecticidal combination of any one of claims 1-6, wherein the combination exhibits synergistic effects.

8) The insecticidal combination of any one of claims 1-7, wherein the weight ratio of the anthranilamide compound of formula (I) and the tau fluvalinate is from 1:1 to 1:50.

9) The insecticidal combination of claim 8, wherein the weight ratio of the anthranilamide compound of formula (I) and taufluvalinate is from 1:1 to 1:4.

10) The insecticidal combination of any one of claims 1-9, comprising about (i) 1-250 g/l of chlorantraniliprole, and (ii) 1-1000 g/l of tau-fluvalinate.

11) The insecticidal combination of any one of claims 1-10, wherein the anthranilamide compound of formula (I) and tau-fluvalinate are applied jointly or in a succession.

12) An insecticidal composition comprising: (i) the combination of any one of claims 1-10; and (ii) an agriculturally acceptable carrier.

13) The insecticidal composition of claim 12, further comprising at least one surfactant, solid diluent, liquid diluent, or a combination thereof.

14) A method for control of chewing pests by contacting the insect or their food supply, habitat, breeding grounds or their locus with a synergistically effective amount of the combination of any one of claims 1-11 or the composition of claim 12 or 13.

15) The method of claim 14, wherein the chewing pests is of the order Coleoptera, Lepidoptera or Orthoptera.
